(19) United States
(12) Patent Application Publication
(10) Pub. No.: US 2014/0358708 A1
(43) Pub. Date: Dec. 4, 2014

(54) Payment Processing with Restricted Receipt Information

(71) Applicants: Richard Scott Perkins, Eagle, ID (US); Kurt Torben Thams, Santa Cruz, CA (US); Daniel J. Shader, Palo Alto, CA (US)

(72) Inventors: Richard Scott Perkins, Eagle, ID (US); Kurt Torben Thams, Santa Cruz, CA (US); Daniel J. Shader, Palo Alto, CA (US)

(73) Assignee: PayNearMe, Inc., Sunnyvale, CA (US)

(21) Appl. No.: 14/189,091

(22) Filed: Feb. 25, 2014

Related U.S. Application Data
(60) Provisional application No. 61/828,699, filed on May 30, 2013.

(51) Int. Cl. G06Q 20/20

(52) U.S. Cl. CPC G06Q 20/204
USPC 705/17

(57) ABSTRACT

A system and method is provided for payment processing with restricted receipt information. In an embodiment, a method is also provided. The method includes receiving a request for billing information from a POS (point-of-sale) terminal at a payment processor for a customer to pay a merchant at the POS terminal. The method further includes providing billing information to the POS terminal. The billing information includes a bill amount and an additional fee amount. The billing information further includes a predetermined code to be included on a receipt from the POS terminal. Matching of the predetermined code on the receipt of the customer and the token document provides proof of payment for the order. The method also includes receiving confirmation of payment from the POS. The method further includes sending payment information to the merchant about the customer payment.

The present application claims the benefit of priority to U.S. patent application Ser. No. 61/828,699.

### BACKGROUND

In some situations, a customer and a merchant seek to engage in an order and fulfillment process, whereby the customer agrees to pay the merchant and the merchant agrees to fulfill a corresponding order. However, the customer seeks to pay in cash or some other payment form that the merchant is not equipped to accept. Thus, it may be useful to provide a system which allows a third party to accept cash or some other payment and to transfer such a payment in some form through a system and potentially other entities to the merchant.

In some such situations, a third party that will accept cash cannot or will not provide significant information on a receipt (e.g. a payment receipt). However, to comply with regulatory and legal requirements, showing that information was provided to the customer may be important. Thus, it may be useful to show that a receipt with limited information is linked to another document, such as an invoice with more information.

### SUMMARY

In an embodiment, a method is provided. The method includes receiving a token document from a customer and accessing a payment processor system. The method further includes requesting payment information from the payment processor based on information from the token document. The method also includes determining a payment amount for the customer based on payment information from the payment processor. The method includes receiving payment from the customer. The method includes providing a receipt to the customer. The receipt includes the predetermined code from the payment processor. Matching of the predetermined code on the receipt of the consumer and the token document provides proof of payment for the order. In some embodiments, the method also includes providing funds to the payment processor related to the payment received from the customer.

In an embodiment, the predetermined code from the payment processor includes exactly four digits. In another embodiment, the predetermined code from the payment processor includes the last digits of an account number for the customer at the payment processor. In yet another embodiment, the last digit of the account number is a checksum digit. In another embodiment, the predetermined code from the payment processor includes exactly four digits which are the last four digits of an account number for the customer at the payment processor and the last digit of the account number is a checksum digit. In another embodiment, the predetermined code is the last digits of an account number for the customer at the payment processor and the last digit of the account number is a checksum digit.

In an embodiment, the predetermined code is composed of alphanumeric digits. In another embodiment, the predetermined code is composed of letters. In yet another embodiment, the predetermined code is composed of symbols and/or numeric digits.

In another embodiment, a method is provided. The method includes receiving a request at a payment processor for billing information from a POS (point-of-sale) terminal. The request is related to a customer request to pay a merchant at the POS terminal using a token document from the merchant having a predetermined code thereon. The method also includes providing billing information to the POS. The billing information includes a bill amount and an additional fee amount and the predetermined code to be included on a receipt from the POS. Matching of the predetermined code on the receipt and the token document provides proof of payment for the order. The method further includes receiving confirmation of payment from the POS and sending payment information to the merchant about the customer payment. In some embodiments, the method further includes receiving funds from the POS terminal related to the payment received from the customer. In some embodiments, the method further includes providing funds from the POS terminal related to the payment received from the customer. In some embodiments, the method includes providing funds from the POS terminal related to the payment received from the customer prior to receipt of funds from the POS terminal.

In an embodiment, the payment information sent to the merchant includes the predetermined code and the bill amount. In another embodiment, the payment information sent to the merchant includes the bill amount. In yet another embodiment, the payment processor receives the predetermined code from a third party entity associated with processing of orders of POS terminals. In another embodiment, the predetermined code from the payment processor includes exactly four digits. In still another embodiment, the predetermined code from the payment processor includes the last digits of an account number for the customer at the payment processor. In another embodiment, the last digit of the account number is a checksum digit. In yet another embodiment, the predetermined code from the payment processor includes exactly four digits which are the last four digits of an account number for the customer at the payment processor and the last digit of the account number is a checksum digit.

In another embodiment, a method is provided. The method includes receiving confirmation at a payment processor of payment from a POS (point-of-sale) terminal for a customer paying a merchant at the POS terminal. The customer uses a token document from the merchant having a predetermined code thereon. The POS terminal provided a receipt to the customer with the predetermined code thereon. Matching of the predetermined code on the receipt of the consumer and the token document provides proof of payment for the order. The method further includes sending payment information to the merchant about the customer payment.

In yet another embodiment, a method is provided. The method includes receiving a request for billing information from a POS (point-of-sale) terminal at a payment processor for a customer to pay a merchant at the POS terminal using a token document from the merchant having a predetermined code thereon. The method also includes providing billing information to the POS, including a payment amount and the predetermined code to be included on a receipt from the POS. The method further includes receiving confirmation of payment from the POS and sending payment information to the merchant about the customer payment.

In another embodiment, a method is provided. The method includes receiving a request for billing information from a POS (point-of-sale) terminal at a payment processor for a customer to pay a merchant at the POS terminal using a token document from the merchant having a predetermined code thereon. The method further includes providing billing information to the POS, including the predetermined code to be included on a receipt from the POS. The predetermined code is the only information from the payment processor on the receipt. The method also includes receiving confirmation of payment from the POS and sending payment information to the merchant about the customer payment.

In another embodiment, a method is provided. The method includes receiving a token document from a customer and accessing a payment processor system. The method further includes requesting payment information from the payment processor system based on information from the token document. The method also includes determining a payment amount for the customer based on payment information from the payment processor system. Additionally, the method includes receiving payment from the customer and providing a receipt to the customer. The receipt includes a predetermined code from the payment processor and the receipt includes no other information from the payment processor. In some embodiments, the predetermined code may come from a third party, such as a POS terminal or management system for a POS terminal. The predetermined code appears on both the token document and the receipt in some form.

In another embodiment, a method is also provided. The method includes receiving a request for billing information from a POS (point-of-sale) terminal at a payment processor for a customer to pay a merchant at the POS terminal. The method further includes providing billing information to the POS terminal. The billing information includes a bill amount and an additional fee amount. In some embodiments, the bill amount and the additional fee amount may be presented to the POS terminal (and thus the customer) as a single unitary number without a breakdown. The billing information further includes a predetermined code to be included on a receipt from the POS terminal as the only information from the payment processor on the receipt. The method also includes receiving confirmation of payment from the POS. The method further includes sending payment information to the merchant about the customer payment.

In still another embodiment, a method is provided. The method includes receiving a request for billing information from a POS (point-of-sale) terminal at a payment processor. The request is for a customer to pay a merchant at the POS terminal using a bill from the merchant with a predetermined code thereon. The method further includes providing billing information to the POS. The billing information includes a payment amount and the predetermined code to be included on a receipt from the POS. The predetermined code is the only information from the payment processor to be included on the receipt. The method also includes receiving confirmation of payment from the POS. The method further includes sending payment information to the merchant about the customer payment.

In yet another embodiment, a method is provided. The method includes receiving a request for billing information from a POS (point-of-sale) terminal at a payment processor. The request is for a customer to pay a merchant at the POS terminal using a bill from the merchant with a predetermined code thereon. Also, the method includes providing billing information to the POS. The billing information includes the predetermined code to be included on a receipt from the POS. The predetermined code is the only information from the payment processor on the receipt. Additionally, the method includes receiving confirmation of payment from the POS. Moreover, the method includes sending payment information to the merchant about the customer payment.

In another embodiment, a method is provided. The method includes receiving a request for billing information from a POS (point-of-sale) terminal at a payment processor for a customer to pay a merchant bill at the POS terminal. The merchant bill has a predetermined code thereon and has disclosure information thereon. The merchant bill is associated with an order staged by a merchant with the payment processor. The method further includes providing billing information to the POS. The billing information includes a payment amount and the predetermined code to be included on a receipt from the POS. Also, the method includes receiving confirmation of payment from the POS. Further, the method includes sending payment information to the merchant about the customer payment.

In still another embodiment, a method is provided. The method includes receiving a request to stage an order from a merchant. Further, the method includes staging the order within a payment processing system. Also, the method includes providing a predetermined code to the merchant. The predetermined code is associated with the order as staged. The predetermined code is to be provided on an invoice to a consumer. Additionally, the method includes receiving a request for billing information from a POS (point-of-sale) terminal at a payment processor. The request is for a consumer to pay a merchant at the POS terminal using an invoice from the merchant. The invoice has the predetermined code thereon. Moreover, the method includes providing billing information to the POS. The billing information includes a payment amount and the predetermined code to be included on a receipt from the POS. The predetermined code is the only information from the payment processor on the receipt. Further, the method includes receiving confirmation of payment from the POS. Also, the method includes sending payment information to the merchant about the consumer payment.

### BRIEF DESCRIPTION OF THE DRAWINGS

The present invention is illustrated by way of example in the accompanying drawings. The drawings should be understood as illustrative rather than limiting.

FIG. 1 is a high-level flow process chart illustrating the relationships between the parties that partake in the presented systems and methods.

FIG. 2 is a high-level flowchart illustrating a method for facilitating transactions, in accordance with one embodiment presented herein.

FIG. 3 is a flowchart illustrating an aspect of the method of FIG. 2.

FIG. 4 is a high-level process chart illustrating one aspect of an embodiment

FIG. 5 is a flowchart illustrating an embodiment.

FIG. 6 is a schematic drawing of a computer system used to implement the methods presented herein.

FIG. 7A illustrates an embodiment of an invoice.

FIG. 7B illustrates another embodiment of an invoice.

FIG. 7C illustrates yet another embodiment of an invoice, in the form of a token document.

FIG. 7D illustrates still another embodiment of an invoice, using multiple barcodes.

FIG. 8A illustrates an embodiment of receipt.

FIG. 8B illustrates an embodiment of receipt.

FIG. 9A illustrates an embodiment of a process of handling payments and fulfillment.

FIG. 9B illustrates another embodiment of a process of handling payments and fulfillment.

FIG. 10 illustrates an embodiment of a process of a customer paying a bill.

FIG. 11 illustrates an embodiment process of a vendor or merchant handling a bill.

FIG. 12A illustrates an embodiment of a process of handling bill payment at a POS terminal.

FIG. 12B illustrates an embodiment of a process of handling bill payment at a POS terminal.

FIG. 13 illustrates an embodiment of processing the payment remotely from the POS terminal.

FIG. 14, illustrated as FIGS. 14A and 14B, illustrates an embodiment of a process of processing a payment and fulfilling a related order for goods and/or services.

FIG. 15A illustrates an embodiment of funds as they may be divided among actors in a transaction.

FIG. 15B illustrates another embodiment of funds as they may be divided among actors in a transaction.

FIG. 16 illustrates relationships between entities involved in fulfillment of an order and potentially related entities in an embodiment.

### DETAILED DESCRIPTION

A system, method and apparatus is provided for payment processing with restricted receipt information. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

The present application is related to co-pending and co-owned U.S. application Ser. Nos. 13/123,067 and 13/087,271, filed Apr. 7, 2011, and Apr. 14, 2011, respectively; the disclosures of which are herein incorporated by reference in their entirety. For example, U.S. application Ser. No. 13/087,271 discloses systems and methods that generally include: (a) staging an order between a merchant and a customer; (b) tokenizing the order by linking one or more order instructions to a token ID; (c) providing the customer with the token ID, wherein the customer can then present the token ID and a payment to a point-of-sale (POS) terminal; (d) receiving confirmation that the customer has presented, to the POS terminal, the token ID and a payment in accordance with the one or more order instructions; (e) notifying the merchant that the customer provided the payment to the POS terminal; and (f) settling the order between the POS terminal and the merchant. The systems and methods presented herein expand on and further develop the settlement process presented in U.S. application Ser. Nos. 13/123,067 and 13/087,271.

Before describing various embodiments in more detail, it is appropriate to define certain terms and phrases. The terms “merchant” and “merchant-partner” are used interchangeably herein. It is noted that the term “merchant” and/or “merchant-partner” is not limited to entities that directly sell goods/services. For example, a merchant may be a loan service, collections service, money transfer service, bill payment service, bank deposit service, credit union, etc. The terms “consumer,” “customer,” and “end-user” are used interchangeably herein. However, it is noted that the use of the systems and methods presented is not limited to sale/purchase orders between a seller and a buyer. The systems and methods presented may be used to facilitate orders between: two individuals, an individual and a business, two businesses, etc. The systems and methods presented may also be used to facilitate orders between any two parties that have a pre-existing relationship or obligation(s). The terms “point-of-sale,” “point of-sale terminal,” “POS,” “POS terminal,” and “point-of-payment” are used interchangeably herein. It is also noted that terms such as “POS” or “POS terminal” may include the actual terminal where payment is presented and received (e.g., the cash register), or may include the POS back office or any entity controlling one or more of the actual terminals. The terms “service provider” and “payment processor” are used interchangeably herein. The term “token” or “payment token” refers to a piece of information which can be used to determine how to process a payment made by a customer at a retail location such as a POS terminal, for example. The term “token document” refers to a document that incorporates or bears or embodies a payment token, and may refer to an invoice, bill, Payslip™ or other type of document, whether in paper, electronic or other form.

The following is a description of one or more embodiments of the present invention, with reference to the figures. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

Various embodiments generally relate to systems and methods for facilitating orders between a merchant-partner and a customer. For example, an embodiment provides a merchant-partner with a means for conducting a cash order via a remote POS terminal. Such an embodiment is particularly useful in facilitating orders such as: sale/purchase agreements, loan repayments, collections, money transfers, bill payments, remote deposits, etc.

In one embodiment, a service provider and/or POS terminal serves as an intermediary between a merchant-partner and the customer. The system allows the customer to pay for the merchant-partner's goods/services in cash (or cash equivalents) at a POS terminal. Other forms of payment may also be received at the POS terminal. The POS terminal and/or service provider then notifies a payment processor and the payment processor notifies the merchant that the customer has made a payment. After the merchant-partner has received a notification, validation, or other confirmation of payment, the merchant-partner can securely complete the agreed upon order between the merchant-partner and the customer.

However, in order for such system to be commercially viable, the systems and methods presented generally include the process steps of: (a) staging an order between the merchant and the customer; (b) tokenizing the order by linking one or more order instructions to a token ID; (c) providing the customer with the token ID, wherein the customer can then present the token ID and a payment to a POS terminal; (d) receiving confirmation that the customer has presented, to a POS terminal, the token ID and a payment in accordance with the one or more order instructions; (e) notifying the merchant that the customer provided the payment to the POS terminal; and (f) settling the order between the POS terminal and the merchant.

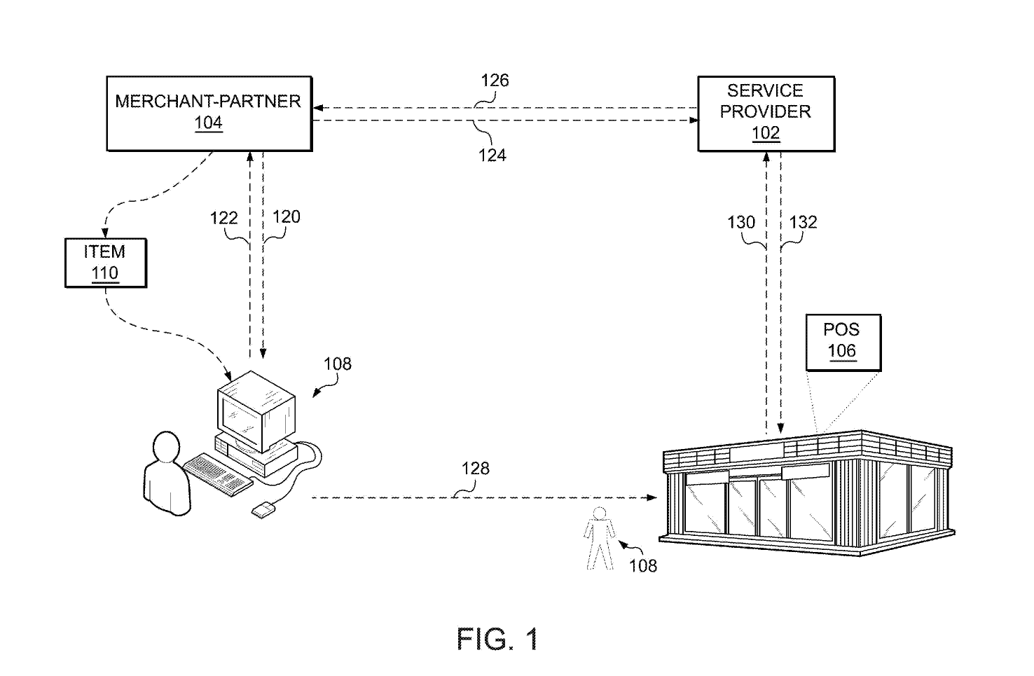

FIG. 1 is a high-level flow process chart, illustrating the relationships between the parties that partake in the presented system 100. In general, system 100 includes four key parties: (1) service provider 102; (2) merchant-partner 104; (3) point-of-sale (POS) 106; and (4) end-user 108. Other parties or entities may be involved, interposed between the illustrated entities or involved without being interposed between the entities illustrated. The dashed lines in FIG. 1 generally represent a flow of information, data, or process between respective parties. In practice, the dashed lines in FIG. 1 represent user interfaces and/or application program interfaces (APIs) for the transmission of information, data, instructions, funds, etc.

As will be described further below, service provider 102 and POS 106 play a central role in facilitating orders between merchant-partner 104 and end-user 108. In one embodiment, each party serves a stand-alone function within system 100. However, in an alternative embodiment, service provider 102 may be incorporated into, or be a functional unit of, merchant-partner 104 and/or POS 106. Further, merchant-partner 104 may be any type of merchant, seller, or retailer; such as an online, web-based merchant, or catalog-based merchant. POS 106 may be a local retailer (e.g., relative to end-user 108), ATM, kiosk, or other cash-exchange terminal, intermediary, or equivalent thereof.

In FIG. 1, process flow 120 and 122 represents an exchange between merchant-partner 104 and end-user 108. In the example shown, merchant-partner 104 provides end-user 108 with a user-interface to purchase a goods/services. For example, the merchant may provide the user with a “checkout” experience over: a webpage on a merchant's website; an interface on a mobile device; an interactive voice system over a telephone network; or any interface equivalent thereto. While known customer user interfaces may provide a “checkout” experience that allows an end-user to enter their credit card information, the system shown in FIG. 1 provides the end-user with a checkout experience that allows the end-user to pay for the goods/services in cash (or cash equivalents).

If the end-user selects to pay in cash, then merchant-partner 104 interfaces and exchanges information with service provider 102, as represented by process flow 124, 126. In practice, merchant-partner 104 and/or service provider 102 stages an order by linking a set of one or more order instructions to end-user 108. The order instructions may vary, but generally include instructions on what actions (e.g., payments) need to be performed by end-user 108 in order for merchant-partner 104 to provide end-user 108 with the agreed upon goods/services (e.g., item 110). The order instructions may include actions to be performed by the end-user 108, merchant-partner 104, service provider 102, or any combination thereof.

Service provider 102 then “tokenizes” the staged order by linking the set of one or more order instructions to a token ID. (The terms “token,” “token ID,” “unique payment identifier,” and “PID” are used interchangeably herein.) In an alternative embodiment, a single token ID can be linked to multiple staged orders and/or multiple merchant-partners. Moreover, the multiple staged orders may be staged at different times or staged as a group, for example. The token ID is then provided to end-user 108. The token ID can be provided to the end-user 108 either directly from service provider 102, or via POS 106 or merchant-partner 104. When end-user 108 is ready to make a payment, end-user 108 presents the token ID to POS 106, along with an appropriate payment, as represented by process flow 128. At POS 106, the token ID serves as a means of linking the end-user's payment to the one or more order instructions.

When end-user 108 presents the token ID and payment to POS 106, the token ID is used to route the presentment information to service provider 102, as represented by process flow 130, 132. Service provider 102 may then validate that the presentment was in accordance with the order instructions linked to the token ID. If the end-user's payment is in accordance with the order instructions linked to the token ID, then service provider 102 notifies merchant-partner 104 that a payment has been made. Merchant-partner 104 then completes the order by, for example, shipping item 110 or otherwise fulfilling the order and/or crediting end-user's 108 account with merchant-partner 104. Service provider 102 then settles the transaction or order between merchant-partner 104 and POS 106 by receiving the payment funds (minus any agreed upon service fees) from POS 106, and delivering the payment funds (minus any agreed upon service fees) to merchant-partner 104.

In an alternative embodiment, the systems and methods described herein do not require merchant-partner 104 to provide end-user 108 with a checkout experience. There is also no requirement that the end-user provide an intent or selection of a cash payment option. For example, in one embodiment, merchant-partner 104 provides its customers with one or more tokens as a means for the customers to make payments. As another example, the merchant provides an invoice or token document embodying a token (e.g. a barcode) to its customer or customers. The payments can be made at a POS terminal, and a series of staged orders may proceed, without any front-end involvement by the end-user.

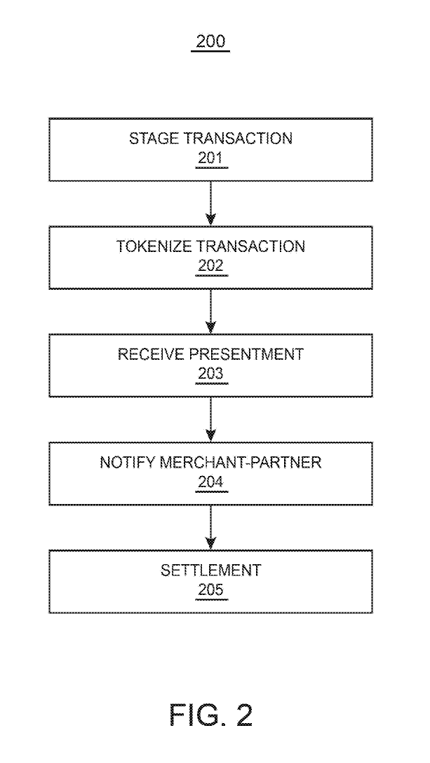

FIG. 2 is a high-level flowchart illustrating a method 200 for facilitating an order between a merchant and a customer, in accordance with one embodiment presented herein. More specifically, FIG. 2 is a flowchart generally illustrating the steps performed in the system described in FIG. 1. The method includes: (a) staging an order (step 201); (b) tokenizing the staged order (step 202); (c) receiving the presentment (step 203); (d) notifying the merchant-partner that the presentment has been received (step 204); and (e) settling the order between the parties (step 205). Additional details for steps (a)-(d) are provided in U.S. application Ser. Nos. 13/123,067 and 13/087,271.

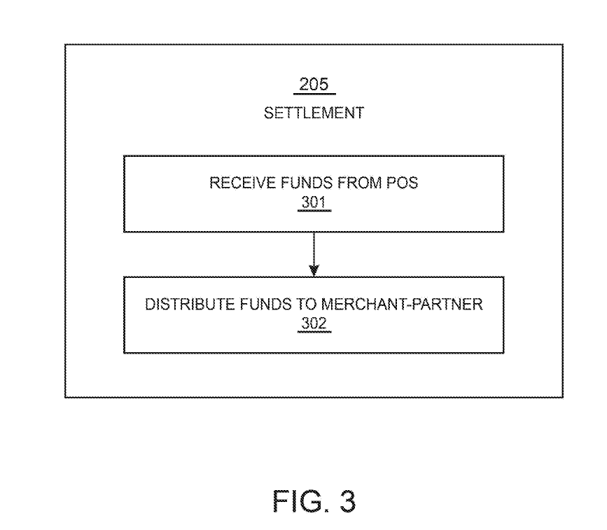

FIG. 3 is a flowchart illustrating the steps of settlement 205, in accordance with one embodiment. In step 301, the service provider receives funds from the POS terminal. In step 302, the service provider distributes funds to the merchant-partner. Receipt and distribution of funds may involve direct and indirect transfers, and may also involve entities interposed between the service provider and the POS terminal or the service provider and the merchant-partner.

In an alternative embodiment, the steps may be reversed in order to meet the settlement requirements of the various parties. The timing of the performance of steps 301 and 302 can also be modified in accordance with the settlement requirements of the various parties. Further, the service provider may adjust the amounts received and/or distributed in accordance with a contractual agreement between the parties. As used herein the phrases “receive funds from POS terminal” and “distribute funds to the merchant-partner” do not require direct communications/transfers between individual entities. Settlement also does not require the actual “touching” of funds. For example, as used herein, to “settle the transaction (or order) between the point-of-sale terminal and the merchant-partner” means to: transfer funds; direct funds; provide an interface for the transfer of funds; and/or otherwise provide the necessary instructions to make sure the funds are properly directed from one entity to another. Further, to “settle the transaction (or order) between the point-of-sale terminal and the merchant-partner” includes communications/transfer with any and all centralized or hierarchical entities that receive funds from individual POS terminals and/or POS back offices at the closing of a defined time period (e.g., a banking day).

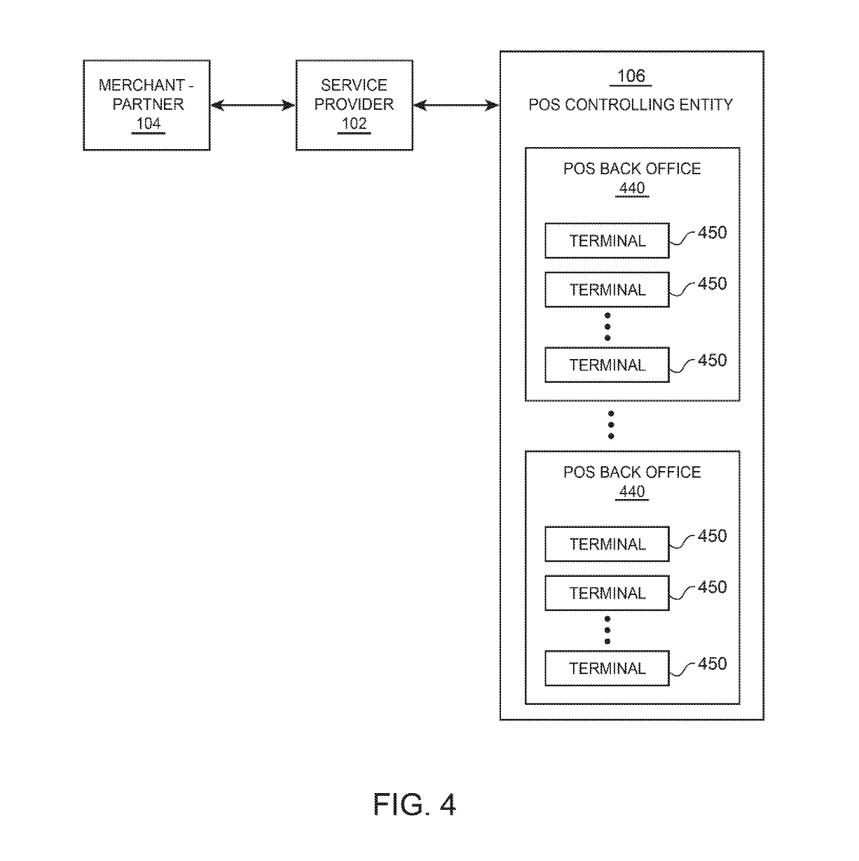

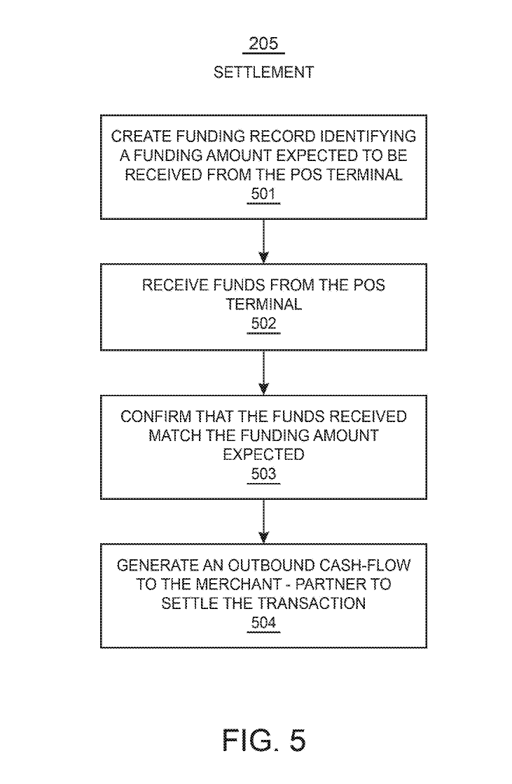

FIGS. 4 and 5 illustrate an alternative embodiment of the settlement process. FIG. 4 illustrates how, in principle, there is a linear relationship between merchant-partner 104, service provider 102, and POS 106. In practice, however, POS 106 may be a centralized controlling entity overseeing a plurality of POS back offices 440 or a centralized entity facilitating operation of a plurality of POS locations, for example. Each POS back office or location, in turn, controls a terminal or a plurality of terminals (e.g., cash registers or POS terminals) 450 where end-users 108 present payment. Because of the variability in (a) when a terminal 450 is officially “closed” or “reconciled” for a given time-period and (b) when a back office 440 is officially closed or reconciled for a given time-period, there is potentially a significant amount of variability in when the actual funds for a particular order are pushed up from a terminal 450, through the POS 106 system, and out to service provider 102. In other words, rarely will service provider 102 receive funds from POS 106 in chronological or matching order with respect to received presentment data, and service provider 102 may not be able to expect chronological or matching order. As such, a settlement process at service provider 102 was engineered to deal with the randomness of terminal 450 closings and back office 440 closings.

FIG. 5 is a flowchart illustrating one embodiment of the settlement process 205. In step 501, a funding record is created to identify a funding amount expected to be received from the POS terminal (or POS 106 generally). For example, service provider 102 may maintain a database with records identifying the presentment data for each order processed through POS terminal 450. Each presentment data point will thus have a respective funding amount expected. In step 502, funds are received from the POS terminal. As mentioned above, the randomness of terminal closings and back office closings creates randomness in the order for which funds are actually received at service provider 102. As such, funds received must be reconciled with the funding amounts expected. In one embodiment, funds are received from POS 106 with a line-item detail file identifying the specific orders that are actually being funded. In step 503, service provider 102 reconciles and/or confirms that the funds received match the funding amounts expected. In other words, service provider 102 tests the line-item detail file received from POS 106 against the funding records of step 501. Moreover, the line item detail file may originate with various entities (e.g. the POS terminal, a controlling entity, a payment processor, etc.) in some embodiments, and such files may be created or processed by multiple entities. As such, service provider 102 can identify which orders have been actually funded, and thus which orders should be paid to merchant-partner 104. In step 504, an outbound cash-flow is generated to merchant-partner 104 to settle the funded orders. In one embodiment, step 504 is performed only after step 503.

In another embodiment, orders are generally paid (e.g. outbound cash-flow is generated to merchant-partner) before orders have been actually funded. Thus, in such an embodiment, step 504 may be performed prior to step 503 for some merchant-partners and/or POS terminals. This may result in further settling or reconciliation of accounts and additional statements to resolve inaccuracies resulting from the need to provide funding to the merchant-partner at step 504 in advance of the transfer of step 503.

Moreover, in some embodiments, a payment location may be invoiced by the payment processor, rather than receiving payments and associated payment information from the payment location on a proactive basis. Additionally, entities may be interposed in this process. This may involve typical commercial actors facilitating funds transfers (e.g. banks). This may also involve entities specific to the type of orders and transactions contemplated here, wherein the entities may facilitate a process of allowing for acceptance of cash payments for orders for which a merchant is not equipped or not well-equipped to handle cash orders.

In one embodiment, there is provided a method of settling an order between a POS terminal and a merchant-partner, wherein the POS terminal receives presentment of a payment for the merchant-partner from an end-user, the method comprising: (a) receiving confirmation that an end-user has presented, to a POS terminal, a payment for a merchant-partner; (b) authorizing the POS terminal to accept the payment from the end-user; (c) creating a funding record identifying a funding amount expected to be received from the POS terminal; (d) receiving funds from the POS terminal; (e) confirming that the funds received in step (d) match the funding amount expected from step (c); and (f) generating an outbound cash-flow to the merchant-partner to settle the order. Step (f) may be performed only after step (e). Step (c) may be performed before step (b). The method may further comprise: (1) asserting to the merchant-partner what amount is owed to the merchant-partner; and/or (2) asserting to the merchant-partner when the amount owed will be released to the merchant-partner. The method may further comprise, after step (c): (1) receiving a line-item detail file from the POS terminal; and (2) reconciling the line-item detail file with the created funding record. The line-item detail file may be a non-chronological database of POS terminal orders. Moreover, the line-item detail file may originate with various entities (e.g. the POS terminal, a controlling entity, a payment processor, etc.) in some embodiments, and such files may be created or processed by multiple entities. Step (d) of the method may further comprise, receiving funds from the POS terminal via a centralized controlling entity, wherein the centralized controlling entity serves as a transaction or order hub for a plurality of POS terminals.

In still another embodiment, there is provided a method of facilitating an order, the method comprising: (a) tokenizing an order by linking one or more order instructions a token ID; (b) providing an end-user with the token ID; (c) receiving confirmation that the end-user has presented, to a POS terminal, the token ID and a payment in accordance with the one or more order instructions; (d) notifying a merchant-partner that the end-user has provided the payment to the POS terminal; and (e) settling the order between the POS terminal and the merchant-partner by (1) creating a funding record identifying a funding amount expected to be received from the POS terminal, (2) receiving funds from the POS terminal, (3) confirming that the funds received in step (2) match the funding amount expected from step (1), and (4) generating an outbound cash-flow to the merchant-partner to settle the order. Step (4) may be performed only after step (3), and step (4) may involve an intermediary, such as a bank, for example. After step (c), the method may further comprises: (1) asserting to the merchant-partner what amount is owed to the merchant-partner; and/or (2) asserting to the merchant-partner when the amount owed will be released to the merchant-partner. Step (e) may further comprise: (1) receiving a line-item detail file from the POS terminal; and (2) reconciling the line-item detail file with the created funding record. The line-item detail file may be a non-chronological database of POS terminal transactions or orders. Moreover, the line-item detail file may originate with various entities (e.g. the POS terminal, a controlling entity, a payment processor, etc.) in some embodiments, and such files may be created or processed by multiple entities. Step (e)(2) may further include receiving funds from the POS terminal via a centralized controlling entity, wherein the centralized controlling entity serves as a transaction or order hub for a plurality of POS terminals.

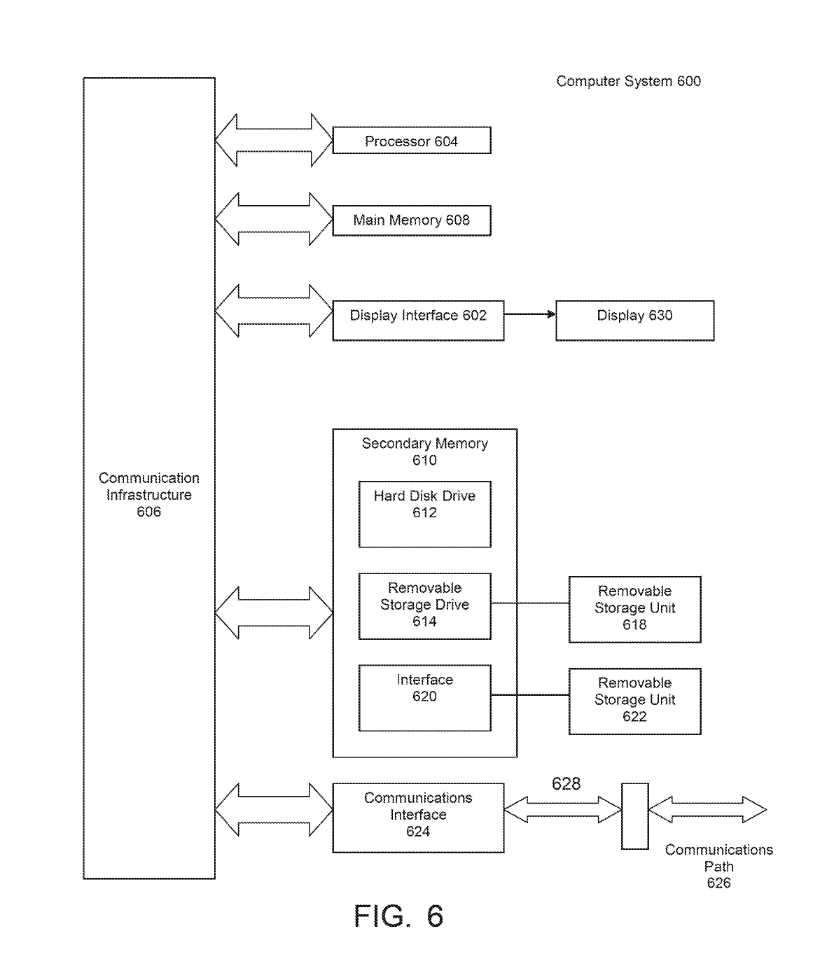

In some embodiments, the system or process is directed toward one or more computer systems capable of carrying out the functionality described herein. For example, FIG. 6 is a schematic drawing of a computer system 600 used to implement the methods presented above. Computer system 600 includes one or more processors, such as processor 604. The processor 604 is connected to a communication infrastructure 606 (e.g., a communications bus, cross-over bar, or network). Computer system 600 can include a display interface 602 that forwards graphics, text, and other data from the communication infrastructure 606 (or from a frame buffer not shown) for display on a local or remote display unit 630.

Computer system 600 also includes a main memory 608, such as random access memory (RAM), and may also include a secondary memory 610. The secondary memory 610 may include, for example, a hard disk drive 612 and/or a removable storage drive 614, representing a floppy disk drive, a magnetic tape drive, an optical disk drive, flash memory device, etc. The removable storage drive 614 reads from and/or writes to a removable storage unit 618. Removable storage unit 618 represents a floppy disk, magnetic tape, optical disk, flash memory device, etc., which is read by and written to by removable storage drive 614. As will be appreciated, the removable storage unit 618 includes a computer usable storage medium having stored therein computer software, instructions, and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow computer software, instructions, and/or data to be transferred from the removable storage unit 622 to computer system 600.

Computer system 600 may also include a communications interface 624. Communications interface 624 allows computer software, instructions, and/or data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, a radio frequency (RF) link, a wireless communication link, and other communications channels. Communications interface 624 may be implemented using custom or proprietary protocols and hardware (e.g. Lightning or Thunderbolt originated by Apple or Intel) or using various standards-based protocols and related hardware, such as Universal Serial Bus (USB) protocols, IEEE 1394 standards-based protocols, or other protocols for data transfer.

In this document, the terms “computer-readable storage medium,” “computer program medium,” and “computer usable medium” are used to generally refer to media such as removable storage drive 614, removable storage units 618, 622, data transmitted via communications interface 624, and/or a hard disk installed in hard disk drive 612. These computer program products provide computer software, instructions, and/or data to computer system 600. These computer program products also serve to transform a general purpose computer into a special purpose computer programmed to perform particular functions, pursuant to instructions from the computer program products/software. Various embodiments are directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the various embodiments, as discussed herein. In particular, the computer programs, when executed, enable the processor 604 to perform the features of the presented methods. Accordingly, such computer programs represent controllers of the computer system 600. Where appropriate, the processor 604, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 600 using removable storage drive 614, interface 620, hard drive 612, or communications interface 624. The control logic (software), when executed by the processor 604, causes the processor 604 to perform the functions and methods described herein.

In another embodiment, the methods are implemented primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both hardware and software.

Various embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) receive confirmation that an end-user has presented, to a POS terminal, a payment for a merchant-partner; (b) authorize the POS terminal to accept the payment from the end-user; (c) create a funding record identifying a funding amount expected to be received from the POS terminal; (d) receive a line-item detail file identifying funds delivered from the POS terminal; (e) reconcile the line-item detail file with the funding record of step (c); and (f) generate an outbound cash-flow to the merchant-partner to settle the order. The line-item detail file may be a non-chronological database of POS terminal transactions or orders. Moreover, the line item detail file may originate with various entities (e.g. the POS terminal, a controlling entity, a payment processor, etc.) in some embodiments, and such files may be created or processed by multiple entities. The computer-readable storage medium may further include instructions executable by at least one processing device that, when executed, cause the processing device to (1) notify the merchant-partner of an amount that is owed to the merchant-partner; (2) notify the merchant-partner of when the amount owed will be released to the merchant-partner; and/or (3) receive funds from the POS terminal via a centralized controlling entity. The centralized controlling entity may serve as a transaction or order hub for a plurality of POS terminals.

In still another embodiment, there is provided a computer base system having: (a) means for receiving confirmation that an end-user has presented, to a POS terminal, a payment for a merchant-partner; (b) means for authorizing the POS terminal to accept the payment from the end-user; (c) means for creating a funding record identifying a funding amount expected to be received from the POS terminal; (d) means for receiving funds from the POS terminal; (e) means for confirming that the funds received match the funding amount expected; and (f) means for generating an outbound cash-flow to the merchant-partner to settle the order. In some embodiments, the POS terminal may be limited in what it can or will provide as information about the order on any receipt issued to a customer. While providing a receipt which shows the amount of money paid or funds transferred may be sufficient in some instances, regulatory and consumer protection considerations may make this situation problematic for some types of orders. For example, the payment processor of FIG. 1 may need to comply with some regulations regarding disclosures, warnings, etc. in order to lawfully process payments. This can be true whether the payment processor operates as some sort of agent for the merchant, the POS terminal/retail site, or the customer. Moreover, the status of the payment processor may vary depending on who the payment processor is deemed to represent with respect to an order. Normally, one can rely on making disclosures on a receipt as proof that a customer agreed to those disclosures during the process of fulfilling an order or otherwise processing an order. However, when the receipt does not allow for one to prove disclosure, one must find another way to demonstrate regulatory and legal compliance.

One may also seek to facilitate some validation of a receipt as part of the proof of payment aspects of order fulfillment. For a situation such as power or gas delivery, where the payment information transmitted through the system of FIG. 1 is sufficient to keep the service on, this may not be terribly important, as one can expect that completion of the order within the system and associated notification to the service provider keeps the service on. If that system somehow fails, proof of payment may turn out to be vital, as it may be the thing which can cause the merchant or vendor to turn power back on, for example. However, for other situations, where proof of payment is necessary to redeem goods or services, this presents a different challenge. For example, if one purchases a ticket to travel from San Francisco to Los Angeles on a common carrier, one likely needs to prove payment to get a boarding pass, or the ticket may be wasted.

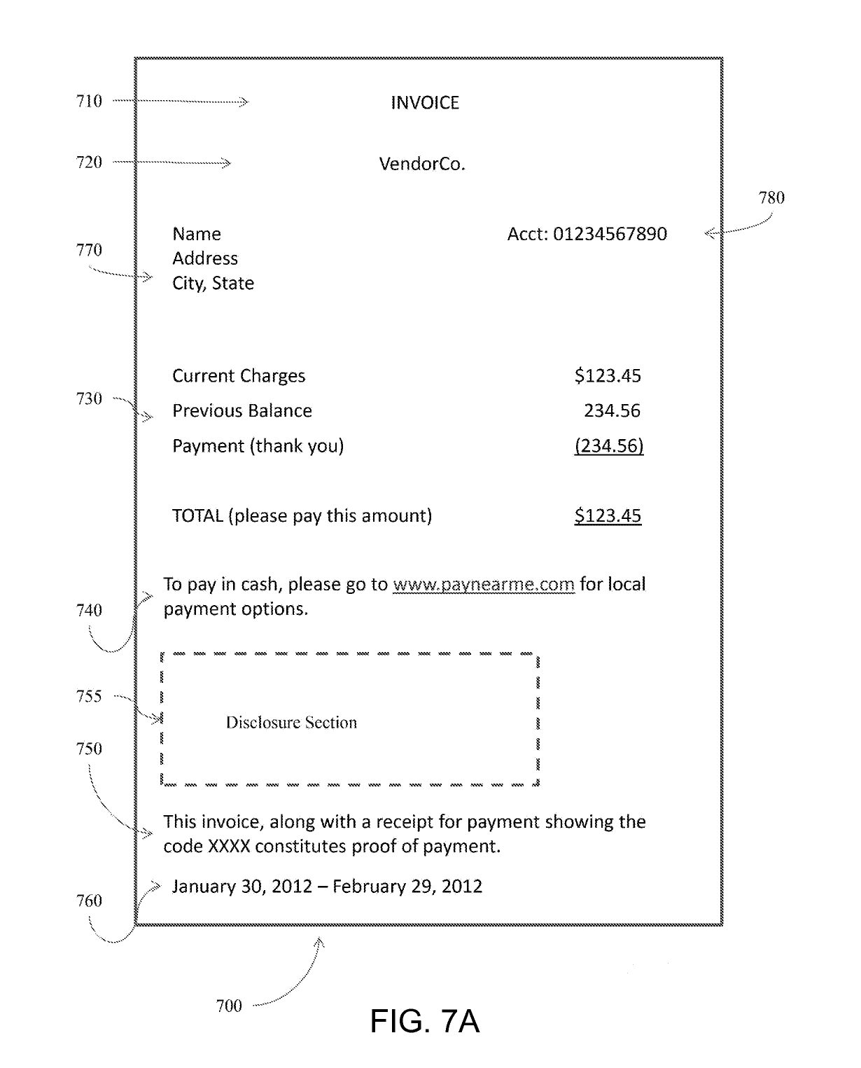

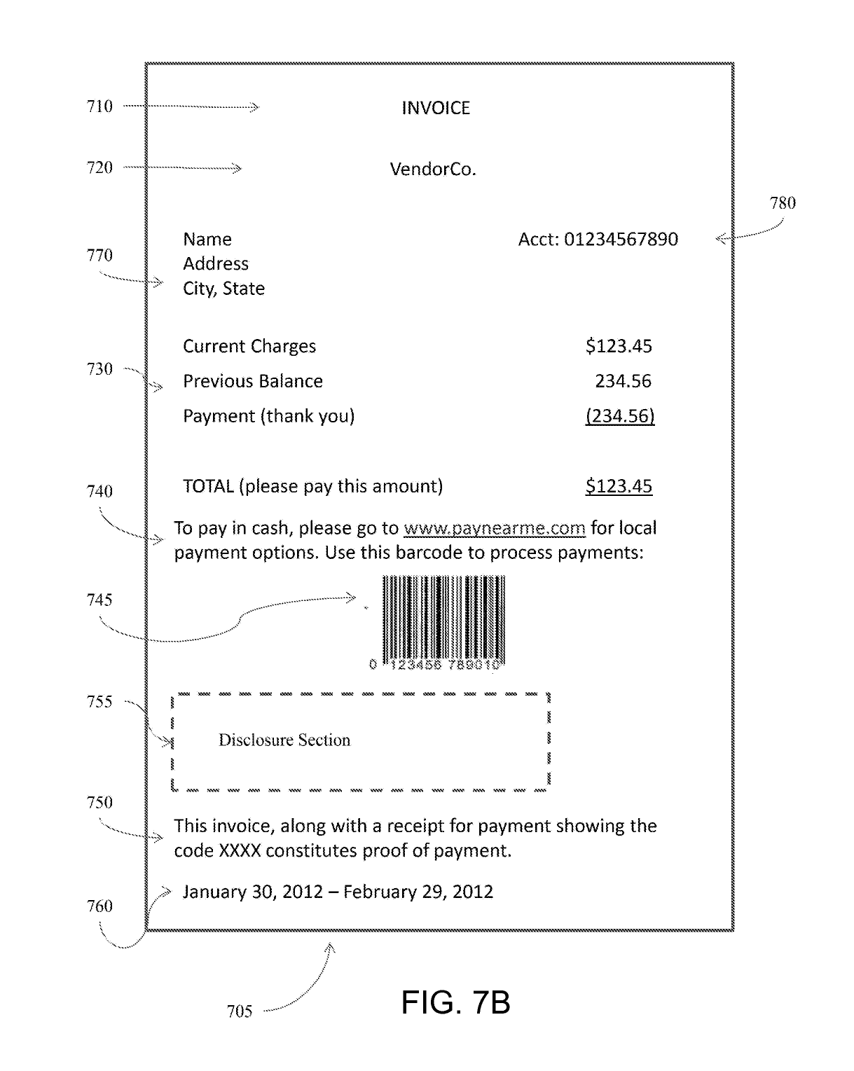

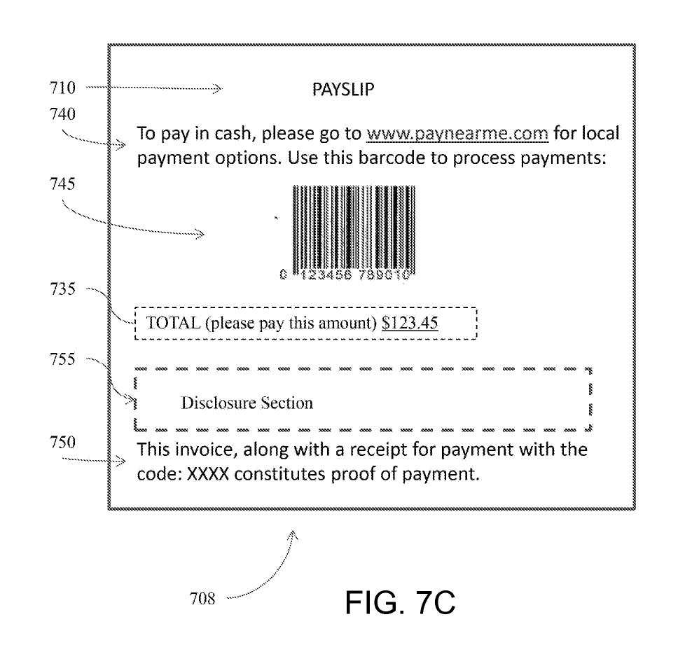

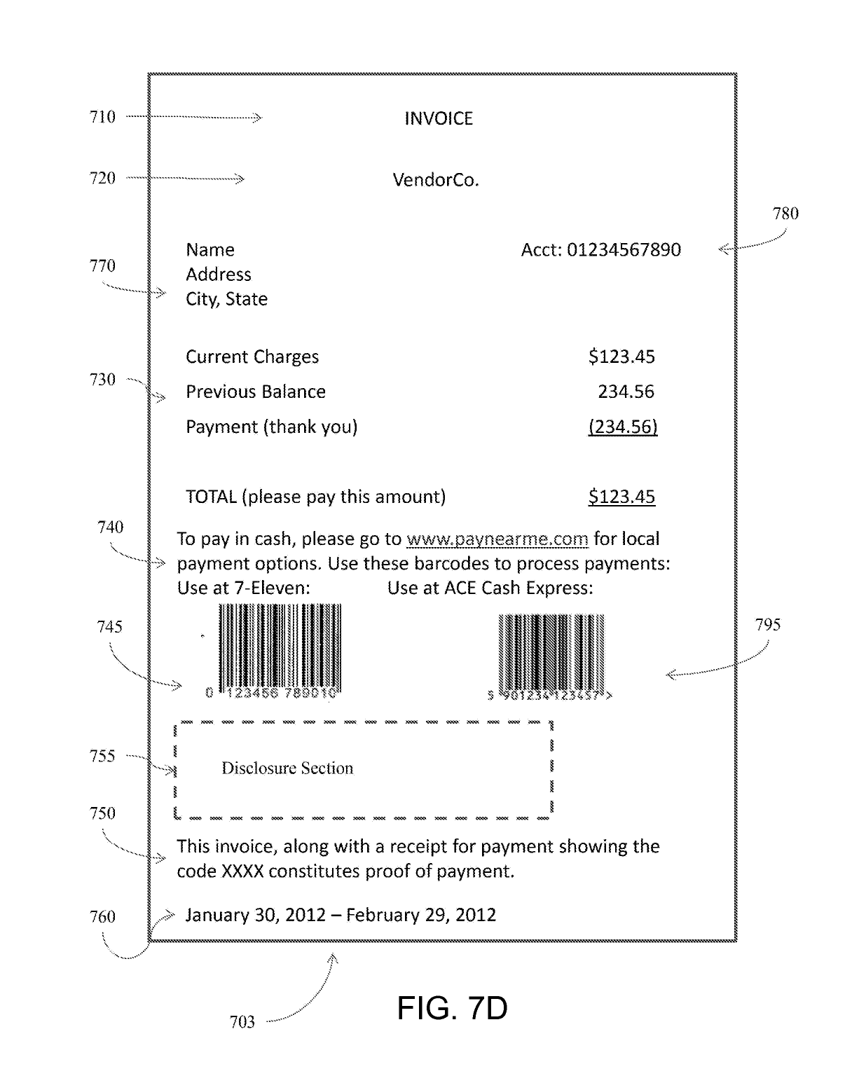

To consider one aspect of how this process may ultimately proceed, one may take an invoice or bill to a POS terminal (such as at a retail establishment) in order to pay the invoice. FIG. 7A illustrates an embodiment of an invoice. Invoice 700 provides basic information which may be used to allow a customer to pay a merchant. Invoice 700 illustrates an example of an invoice received by a customer or provided by a merchant or vendor may look like. However, variations on invoices are potentially infinite. Invoice 700 may be used as a token document incorporating a token or token ID in conjunction with the system of FIG. 1, for example (the token or token ID may be perceptible to humans, or encoded in some manner, such as through a barcode, for example). A vendor or merchant (e.g. a merchant-partner) may issue invoice 700 (e.g. an invoice or bill for goods or services) and allow a customer to use a POS terminal at a local location (e.g. a local store) to pay for invoice 700. Along with issuance of invoice 700, the merchant or vendor may be expected to stage an order with a payment processor associated with invoice 700, such that a consumer or customer may then take invoice 700 in for payment and use the system of FIG. 1 to accomplish payment for goods or services.

Invoice 700 includes a title 710 indicating that it is an invoice and an originator 720 indicating which vendor or merchant the invoice came from. Address block 770 and account number 780 provide information about a customer and an account the customer has with merchant 720. Payment information 730 provides information about current charges and the amount owed by the customer. Announcement 740 provides information about how the invoice may be paid. Billing period 760 provides an indication of what period of time is represented by the invoice.

Code section 750 provides a code which matches a code upon a receipt after payment, to allow for proof of payment. In one embodiment, the code of code section 750 is provided by a payment processor for incorporation into an invoice, bill or token document by a merchant (or may be incorporated by the payment processor into the document for the merchant). In another embodiment, the code of code section 750 is provided by a system of POS terminals or a system supporting POS terminals or retail locations, with the code provided to a payment processor and thence to a merchant or vendor.

Disclosure section 755 provides regulatory and legal compliance disclosures believed to be necessary to allow for processing of the order. These disclosures may be based on where an invoice originates, where a customer resides, or where an order is expected to take place, for example. Moreover, such disclosure statements may be mandated by various different agencies, such as consumer protection bureaus, financial regulatory agencies, local, regional, state, provincial or national agencies, and other types of regulators. Additionally, disclosure section 755 may include information about voluntary disclosures as part of industry norms or based on company policies.

Note that variations may be used for all aspects of invoice 700. For example, one may only show part of an account ID 780, with the rest masked or omitted, for example. Similarly, one may leave off a title 710 or time period 760, for example. Moreover, one may expect that the actual barcodes illustrated may occur in other forms, such as formats that encode more digits. Also, barcodes may be replaced by other visual encoding formats, such as QR codes, for example.

FIG. 7B illustrates another embodiment of an invoice. FIG. 7B illustrates an alternative invoice which includes a barcode 745. Barcode 745, in an embodiment, provides an encoded form of information about the type of order and the specific order, or other information related to the order associated with invoice 705. Some examples of such information are provided below, but other variations may also be used. Barcode 745 may be used to arrange for payment of invoice 705 through use of a POS terminal, for example. Thus, barcode 745 may encode information about how invoice 705 is to be paid, what additional fees are added for processing, how fees are split and so on. When the barcode is not incorporated, such as in FIG. 7A, one may use other information from the invoice 700 to determine an implied token for the order.

FIG. 7C illustrates an embodiment of a token document. Thus, FIG. 7C illustrates an alternative form of an invoice (token document 708) which may be used in other contexts from invoice 705. Barcode 745 may be used to arrange for payment of invoice 708 through use of a POS terminal, for example. Total 735 may optionally be included in token documents for specific amounts, and in some contexts may be provided in a more informal or handwritten form, for example. In other contexts, token document 708 may allow for the payment of any amount, and total 735 may simply be left off of the document. Token document 708 generally provides many of the same aspects in an order that invoice 705 provides, with a different visual format. Thus, token document 708 may be expected to be associated with some form of order staged with a payment processor by a merchant or vendor. In the case of a situation where token document 708 is provided at initiation of an order, one may expect that some form of order has previously been staged by or for the merchant, such as when the merchant agreed to use token document 708. Some details of such an order (e.g. identity of the merchant or vendor) may be known when the merchant agrees to use the token document. Other details (e.g. identity of the consumer, amount of the payment for the order) may not be known until the order is executed, for example.

Using UPC codes can also lead to other variations on an invoice or token document, for example. FIG. 7D illustrates an embodiment of another invoice. Illustrated in FIG. 7D is use of multiple barcodes to encode different payment economics for different processing of an order through different retail sites. Thus, barcode 745 is included as with invoice 705 of FIG. 7A. However, barcode 795 is also included on invoice 703 to allow for different processing at two different types of retail locations. Thus, one may expect that barcode 745 encodes a first UPC code related to a first set of payment economics for a first retail location. Barcode 703 encodes a second UPC code related to a second set of payment economics for a second retail location. Information 740 indicates which barcode to use at which retail location, for example. Payment economics relate to how payments are split up between various actors or entities involved in fulfilling an order, including the payment processor, POS terminal/retail location, merchant, and potentially other entities as well.

Note that an invoice, bill or token document need not be provided in physical (e.g. paper) form. One may receive such a document via email, by accessing a website, or by downloading information in a dedicated software application on a computing device, for example. Moreover, one may access such information on various different types of computing devices, such as mobile devices, personal computers, tablets, laptops, or other devices. Additionally, one may encode the relevant information in an accessible way in various media or associated structures. Thus, one can provide the relevant information from an invoice or token document in an apparatus with a magnetic stripe, NFC (near-field-communication) capabilities, RFID (radio frequency identifier) capabilities, or other structure. Provided that a payment site has the capability to interact with the structure in question, a payment can be processed.

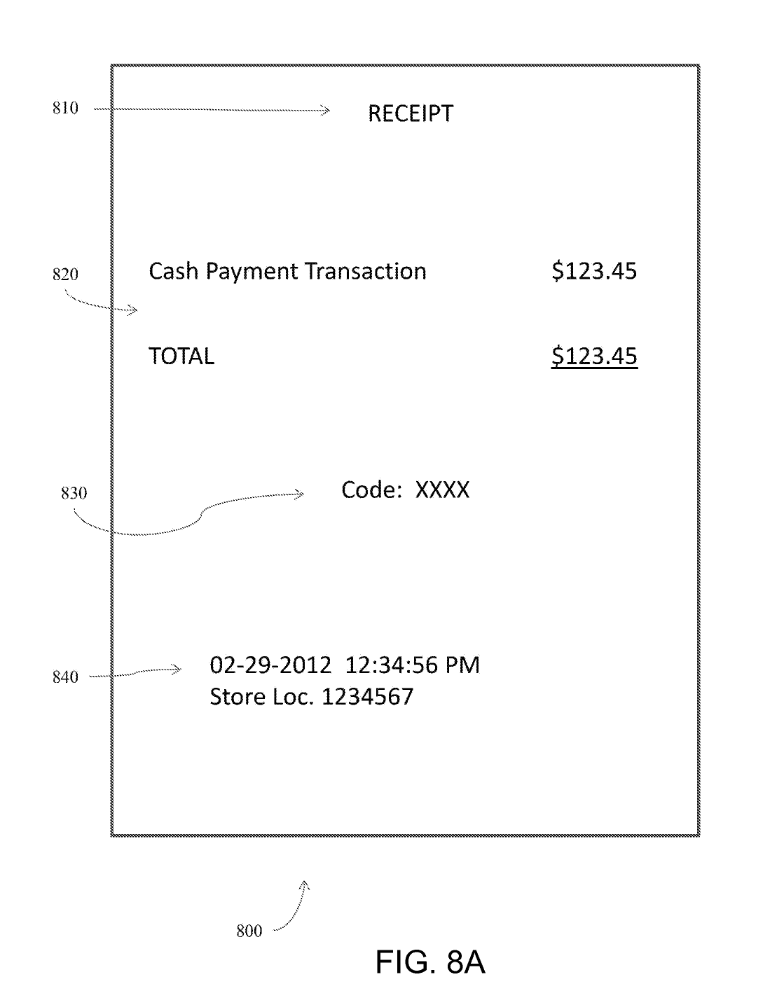

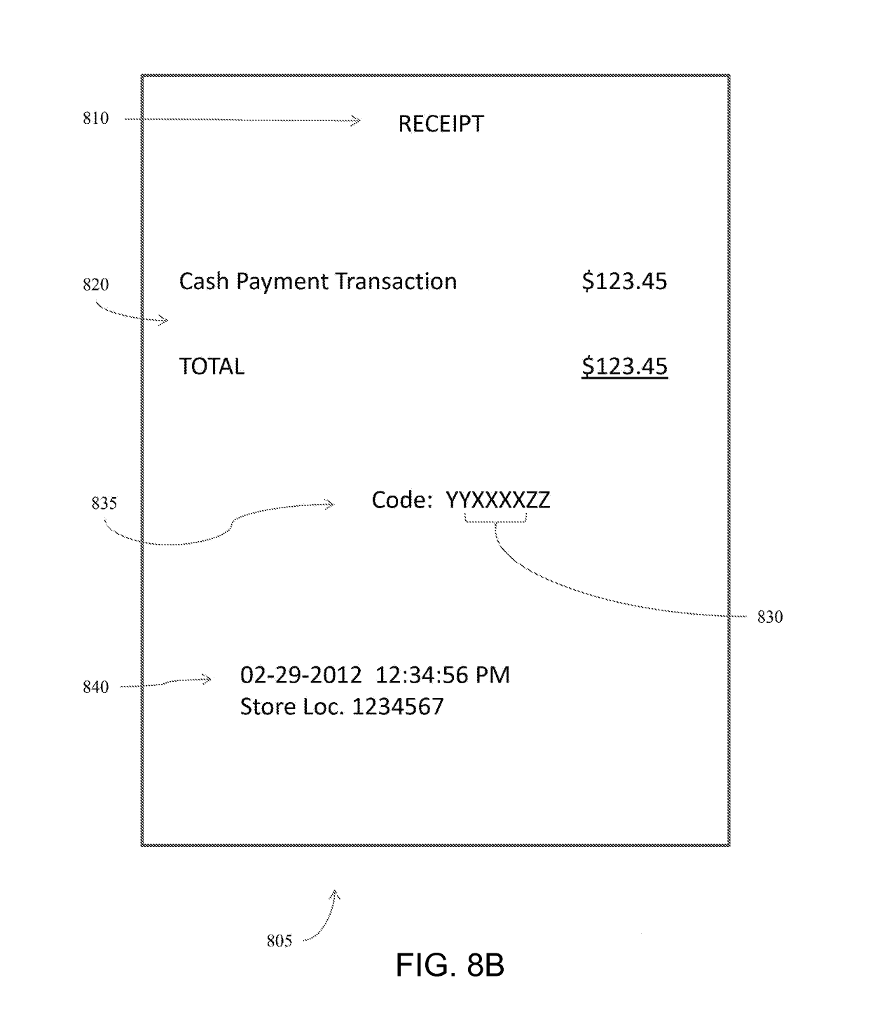

Upon payment of an invoice, a receipt is issued. FIG. 8A illustrates an embodiment of a receipt. In some instances, the receipt does not provide any indication of the type of payment, other than a code. Thus, receipt 800 is illustrated as including a title 810 (optional), payment information 820 (what was paid), code 830 and tracking information 840.

Tracking information 840 may be expected on most receipts, and thus may back up information about when and how a payment was made. Code 830 provides information specific to the system illustrated in FIG. 1, indicating how the payment can be associated with a specific customer, vendor, etc. Payment information 820 provides evidence of what was actually paid (e.g. $123.45 paid in cash as illustrated). When code 830 is assigned based on the invoice (e.g. invoice 700) which is paid, this can allow for a lock-and-key type of approach wherein the code 830 along with the invoice 700 (specifically section 750) provide proof that payment was made without other additional information. Collectively, a receipt received by the customer and the token document, invoice or bill provide proof of payment if the codes match on both documents. Moreover, invoice 700 in conjunction with receipt 800, bearing matching codes in sections 750 and 830 may provide proof of regulatory compliance, for example.

Code 830 is illustrated as a four-digit code printed on the receipt, and this may be all that some POS terminals can supply, or all that some system managers will be willing to supply. Thus, code 830, in some embodiments, is provided by the processor which processes the payments remotely to make sure that the payment can be matched with the appropriate invoice. In an embodiment, each order generates a 19 digit order identifier internally within the system. This order identifier serves as an account number for the order or for the customer in some instances.

Furthermore in some embodiments, the 19-digit order identifier is randomly generated or sequentially generated, with a checksum digit as the last digit of the order identifier. Thus, the last four digits of the order identifier can be used to provide the code identified in receipt 800. With the checksum digit in place, simply faking the code becomes harder, as the checksum is dictated by information which is not available to someone unless they have access to the payment processor system. That information is not on the receipt, and the code on the receipt is not a simple sequential order number, for example.

FIG. 8B illustrates an alternative in which the code is embedded in a larger format. Code 830 is shown as part of code section 835, which may surround the code with other digits, mask part of the code in some manner or otherwise make reproduction of the code difficult. This may be necessary as part of a system in which the POS terminal or retail site operates, or for other reasons such as security, for example.

The code may be provided by a third party, such as an entity facilitating access to a network of POS terminals or retail sites, rather than the payment processor. In such an instance, the code would be obtained from the entity in advance of or at the time of staging of the order so the payment processor could provide the code for use on the invoice or token document. The code would then be provided on the receipt in conjunction with processing of the order at a POS terminal or retail site to allow for the match of codes on the invoice and receipt. In some embodiments, the order identifier, rather than the code is provided by a third party. This may take the form of a third party specifying a sequence of order identifiers to be used, or it may involve a third party specifying a valid range or set of order identifiers from which a payment processor may choose.

Note that the number of digits need not be exactly four where a system can or will allow for more (or fewer) digits. Also, other codes can be used, such as a code generated separately for the order or sequentially for the order process. Moreover, one can use a different order identifier rather than a 19 digit order identifier in some embodiments. In some embodiments, a 16 digit order identifier is used. In other embodiments, a 12 digit order identifier may be used, for example. An order identifier may be used in a space that is larger than the order identifier itself, with fill or pad digits included, or with additional check digits (e.g. checksum digits) included, too. Thus, one may use a 16 digit identifier within 19 digits, with the extra three digits provided as fill digits. The fill digits may be the first three or the last three digits of the 19 digits, if a 16 digit order identifier is used in a 19 digit space. Moreover, a check digit may not be used in some instances. In yet other embodiments, identifiers of varying sizes are used, some with and some without checksums. Additionally, the term digits is used, but this may refer to alphanumeric, alphabetic (letters), numeric, symbolic or other items which may be used in a character set, for example.

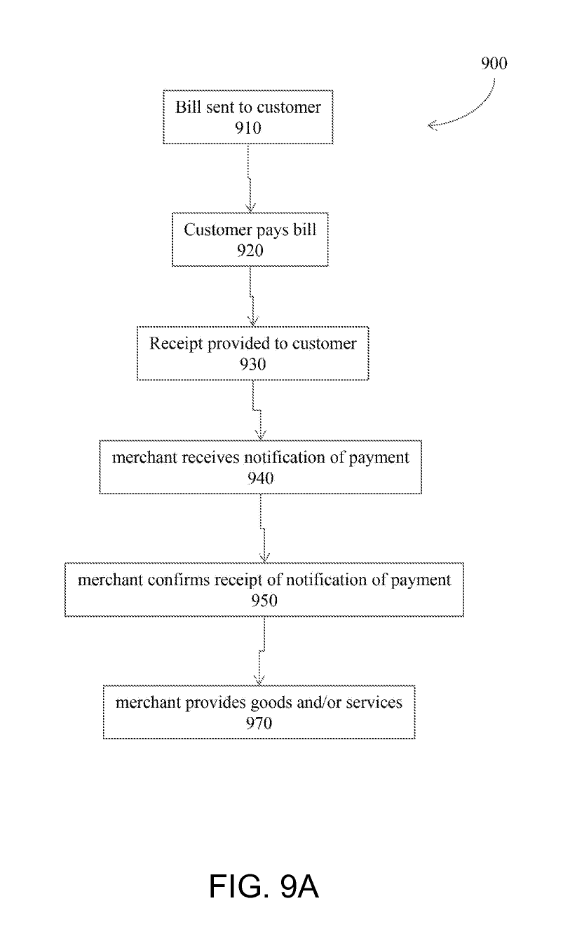

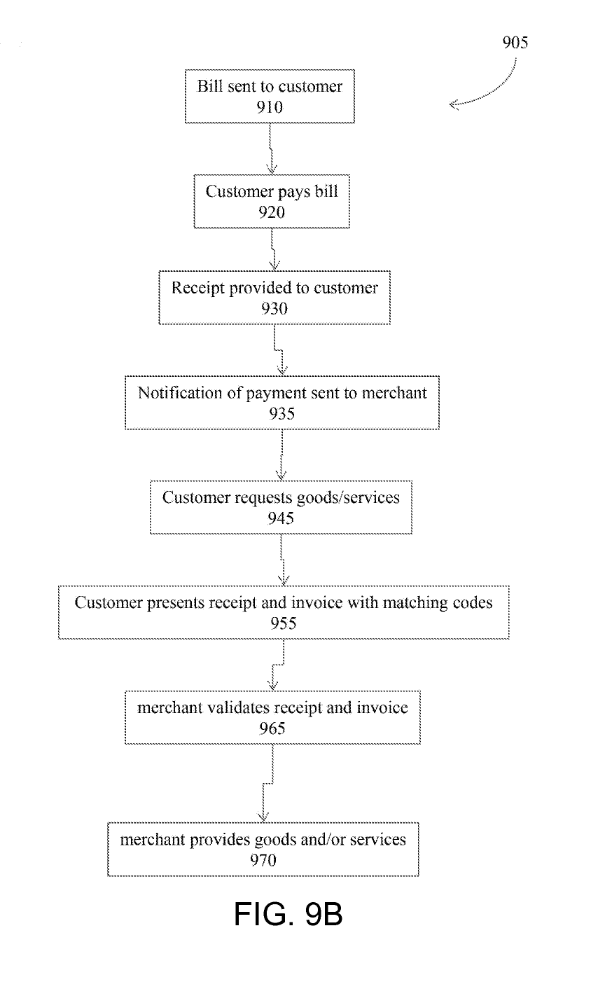

The payment process is handled by a variety of actors, as illustrated in FIG. 1. FIG. 9A illustrates an embodiment of a process of handling payments and fulfillment, as may be implemented by a system such as that shown in FIG. 1. Process 900 provides the basic process for handling payments and fulfillment related to bills. Process 900 and other processes of this document are implemented as a set of modules, which may be process modules or operations, software modules with associated functions or effects, hardware modules designed to fulfill the process operations, or some combination of the various types of modules, for example. The modules of process 900 and other processes described herein may be rearranged, such as in a parallel or serial fashion, and may be reordered, combined, or subdivided in various embodiments.

Process 900 initiates when a bill is sent to a customer at module 910, such as via mail or email to the customer. The bill may be expected to include disclosures and a code, for example. At module 920, the customer pays the bill, such as by taking the bill to a POS terminal at a store and paying it there. At module 930, a receipt is provided to the customer. The receipt may be expected to incorporate the code, allowing for matching of the receipt and bill or invoice. Along with provision of a receipt at module 930, notification goes to a vendor or merchant at module 940, providing the details of the order. The merchant then confirms receipt of the notification at module 950 (this may be optional in some embodiments). The merchant further provides goods or services at module 970. This process allows for payment at a third-party site by a customer, who then receives good and/or services from a merchant as agreed. Underlying this process is an assumption that the merchant receives notification of the payment properly and that there is no need for proof of payment.

FIG. 9B illustrates an embodiment of an alternative process of handling payments and fulfillment, as may also be implemented by a system such as that shown in FIG. 1. Process 905 provides another basic process for handling payments and fulfillment related to bills. Process 905 initiates when a bill is sent to a customer at module 910, such as via mail or email to the customer (with code, and any disclosure section). At module 920, customer pays the bill, such as by taking the bill to a POS terminal at a store and paying it there. At module 930, a receipt is provided to the customer (with code). Additionally, at module 935, notification of the payment and order details is sent to the merchant.

With the receipt, the customer goes to a merchant at module 945, requesting the paid for goods and/or services. Further, at module 955, the customer presents both the receipt and the original bill, showing the matching codes. At module 965, the merchant validates the receipt and bill by requesting information. This may be based on simple visual inspection, or may involve requesting information about the receipt and bill from a payment processor. Having determined the receipt and bill are valid, the merchant provides goods or services at module 970. Note that this presents a system where the match of the codes on the invoice, bill or token document and receipt provide proof of payment. Consumers or customers may approach non-performing vendors or merchants in a variety of ways and for a variety of reasons, ranging from a misunderstanding through a situation of lost information to outright failure to perform. For purposes of this system, the presentation of the matching codes of the bill and receipt serve as proof of payment.

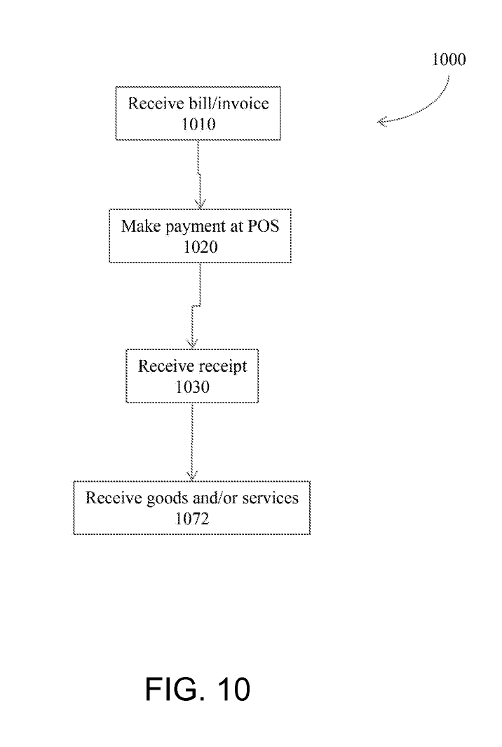

Various actors each experience a different process, whether the process 900 of FIG. 9A, the process 905 of FIG. 9B, or another process with similar components comes into play. FIG. 10 illustrates an embodiment of a process of a customer paying a bill. Process 1000 initiates when a customer receives a bill or invoice at module 1010, with the bill or invoice including a code for matching purposes and any predetermined disclosure information. The customer then takes the bill to a POS terminal and makes a payment at module 1020. Upon making the payment, the customer receives a receipt at module 1030 with a code matched to the code of the bill or invoice. At module 1072, goods and/or services are received by the customer, such as through delivery of goods, a boarding pass, or performance of services as agreed.

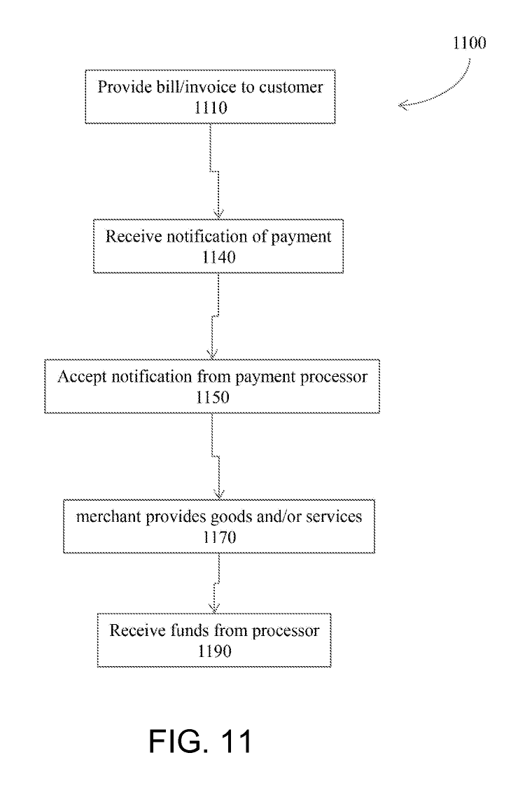

A vendor or merchant partner has a different experience relative to the customer. FIG. 11 illustrates an embodiment of a process of a vendor or merchant handling a bill. Process 1100 initiates with a vendor or merchant partner sending a bill or invoice to a customer at module 1110. The bill or invoice includes a code for matching purposes obtained by the merchant when a corresponding order was staged with a payment processor. At module 1140, the merchant now receives a receipt showing payment along with the bill. The receipt also includes the matching code to the code found on the invoice or bill. Collectively, a receipt received by the customer and the token document, invoice or bill provide proof of payment if the codes match on the two documents, but the notification may be all that the merchant actually receives in some scenarios. At module 1150, the merchant accepts the notification from the payment processor (e.g. by acknowledging receipt of the notification, or simply recording the notification). With the payment received, the merchant provides goods and services at module 1170. Additionally, the merchant receives funds from the payment processor at module 1190. Note that the funds received from the processor at module 1190 may be received prior to presentation of the receipt and bill by the customer, or without presentation of such receipt and bill Likewise, the funds received at module 1190 may be received well after presentation of the receipt and bill by the customer.

Note that process 1100 assumes that the bill is related to an order previously staged with the payment processor. Types of orders that may be staged vary greatly. For example, one may stage a straightforward order for pickup or delivery of goods from a merchant, and arrange for payment thereby. Alternatively, one may stage an order or series of orders for a service from a merchant. As another example, one may stage an order or series of orders for an ongoing service (e.g. provision of power to a residence, for example). Moreover, one may stage an order or series of orders for a more abstract obligation, such as repayment of a mortgage (or loan) and a corresponding agreement to not foreclose on mortgaged property (or seize secured property), for example.

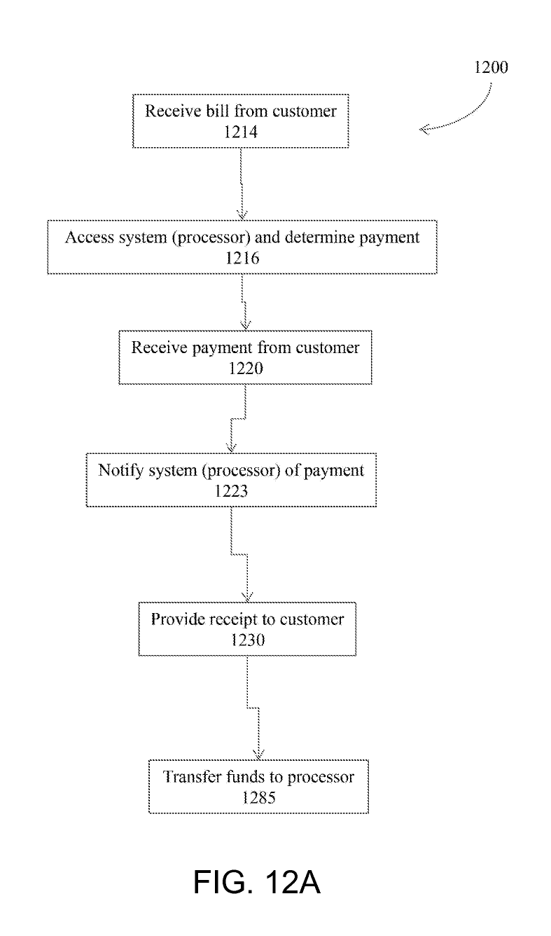

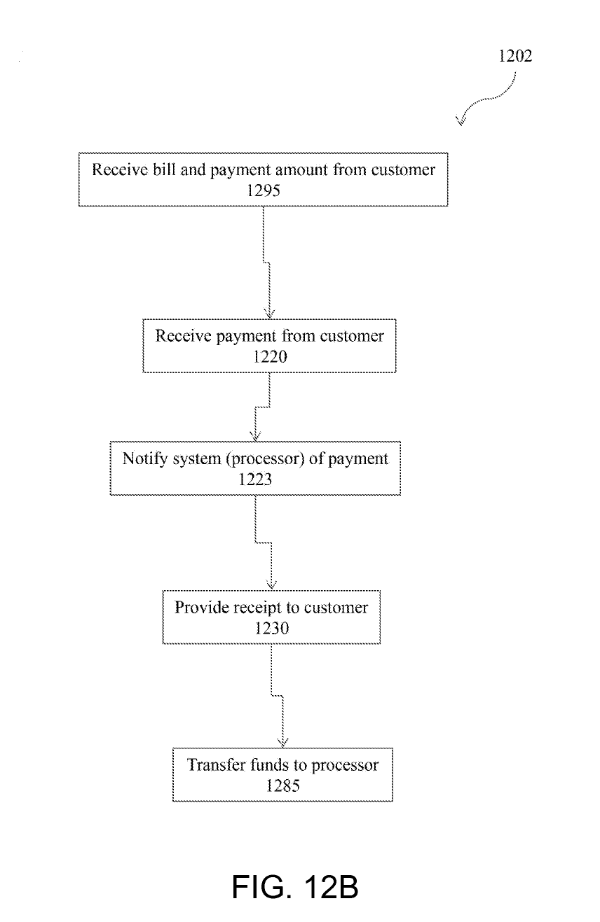

In handling the payments, the POS terminal has yet another process. FIG. 12A illustrates an embodiment of a process of handling bill payment at a POS terminal. Process 1200 initiates when a bill is received from a customer at a POS terminal at module 1214. The POS terminal accesses a payment processor and determines an appropriate payment. This occurs at module 1216, and may involve determining both an amount owed and any additional fees which should also be paid as part of the order. At module 1220, payment is received from the customer. Typically, payment will be in cash, but may also be in the form of a credit card or debit card payment, for example. Payment may also come in the form of some sort of cash equivalent, such as a voucher provided by a third-party to the customer, or a gift card, for example.

With payment received, the POS terminal notifies the system payment processor of the payment received at module 1223 and a receipt is provided to the customer at module 1230. The receipt includes a predetermined code which is issued by the POS terminal, but may originate from the payment processor or a third party. Eventually, funds are transferred to the processor at module 1285. Note that the notification of module 1223 may be expected to be fairly quick after payment occurs, potentially instantaneous. However, funds transfer to the payment processor module 1285 may occur very quickly or after a long period of time.

In an alternate embodiment in FIG. 12B, the bill and payment amount come from the customer at module 1295 of process 1202. Thus, rather than accessing the payment processor at the start of the process, the POS terminal may simply process the payment and notify the processor at module 1223 along with receiving the payment. In such an instance, the payment processor may provide a code for the receipt upon notification, or the code from the invoice may be obtained by the POS terminal either automatically or manually for provision on the receipt at module 1230.

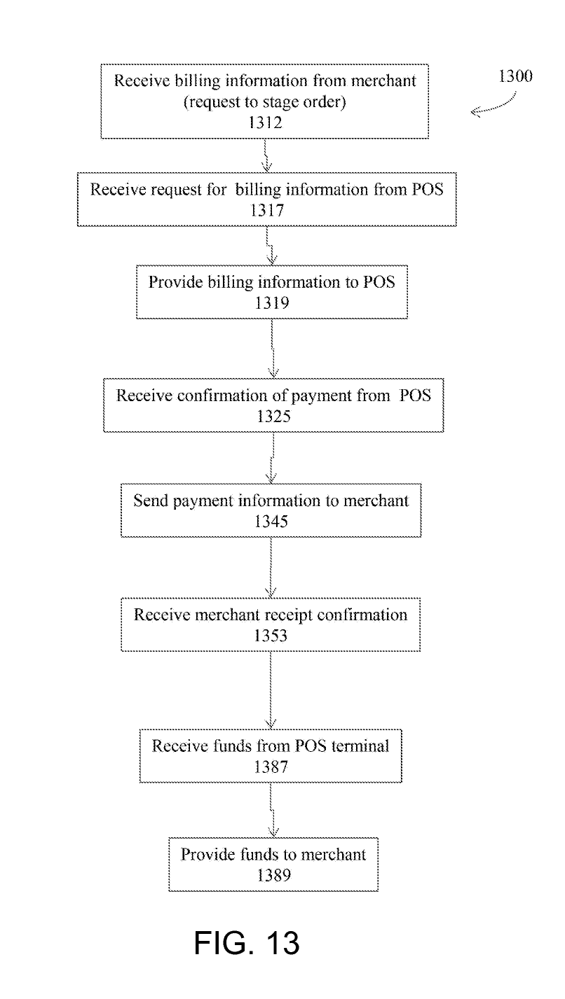

Ultimately, the payment processor facilitates the order and fulfillment thereof. FIG. 13 illustrates an embodiment of processing the payment remotely from the POS terminal. Process 1300 initiates with receipt of billing information from the merchant at module 1312. This billing information may include, for example, information about bills generated by the merchant which are payable through the payment processor. Such information may include amounts of bills, account numbers, account holder information, and other related information for such bills. As with the process/system of FIG. 1, the payment processor may acknowledge the request to stage an order. Moreover, the payment processor may provide a predetermined code to the merchant for use in any merchant invoice or token document. At module 1317, a request is received for billing information from a POS terminal. At module 1319, billing information is provided to the POS terminal, including the predetermined code for use on the POS terminal receipt in some embodiments.

Alternatively, the merchant may not provide billing information, and the payment processor may only provide information about how an order should be processed (e.g. additional fees) at module 1319. In such an instance, an order would have been staged as part of the process of setting the merchant up to use orders with the payment processor, and predetermined codes would be provided as part of the setup process, too. Moreover, in some embodiments, the payment processor may, upon receiving a request to provide billing information at module 1317, query the associated merchant as to whether the merchant will accept the payment, and await confirmation of willingness to accept before providing billing information at module 1319. This additional set of modules is not shown here.

At this point, a merchant has provided some billing information related to the customer and the customer has gone to a POS terminal and made a payment against an associated bill including a predetermined code. At module 1325 confirmation of payment from the POS terminal is received. Payment information is then sent to the merchant at module 1345, reflecting the information received at module 1325. Presumably, thereafter, the customer goes to the merchant with proof of payment in an attempt to receive goods or services, or the merchant may simply deliver goods and/or services as agreed. A merchant receipt confirmation (e.g. an acknowledgment of receipt of payment information from the payment processor) is received at module 1353.

At module 1387, funds are received from the POS terminal where the payment was made by the customer. At module 1389, funds are provided to the merchant. Note that some of these modules may be executed in a different order from that shown in FIG. 13. For example, in some instances funds may be provided to the merchant at module 1389 before funds are received from the POS terminal module 1387. Similarly, these transactions of funds may occur soon after confirmation of payment from the POS terminal at module 1325.

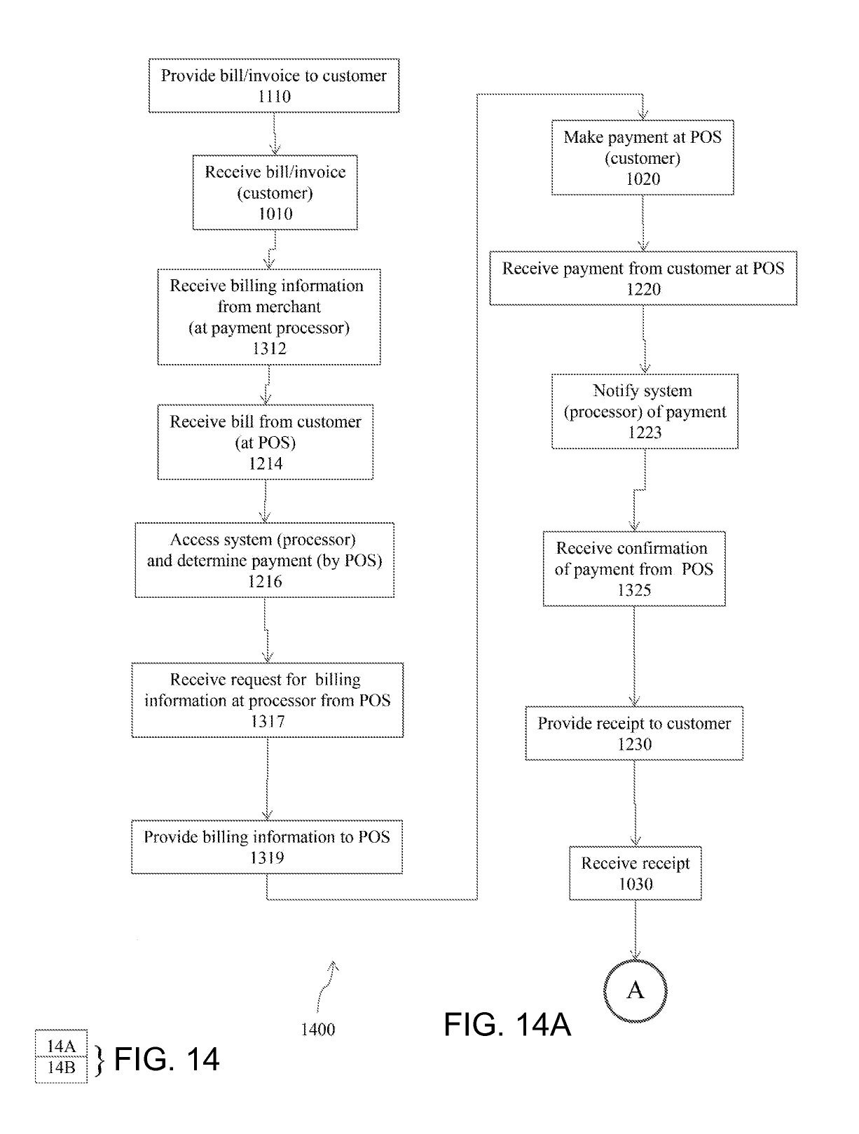

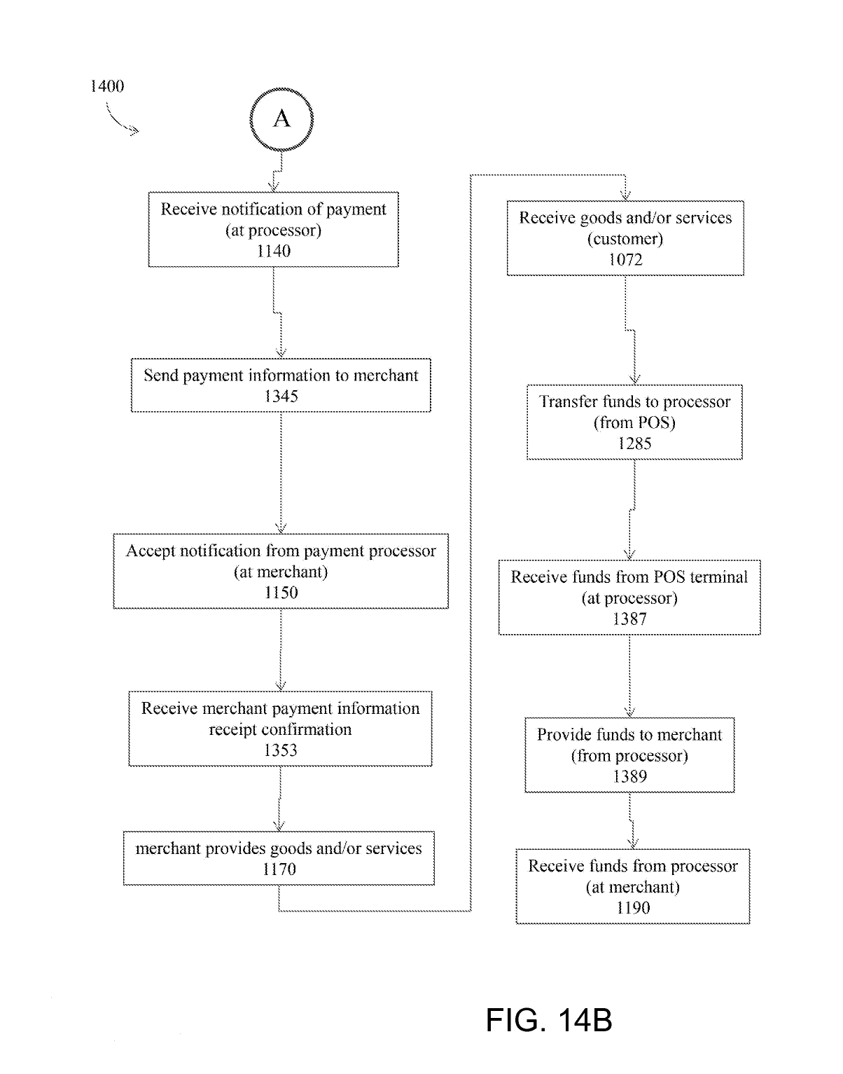

The process 1400 of FIG. 14 further illustrates the overall interaction of the various actors within the system. Process 1400 is illustrated as FIGS. 14A and 14B, which collectively make up FIG. 14, and shows the various modules executed by the actors using each individual process along the way, along with how these modules may relate sequentially in one embodiment. Each module referred to herein has an analogous module among FIGS. 10, 11, 12 and 13, so some details are omitted here for the sake of clarity. No difference between descriptions should be viewed as contradicting the earlier descriptions, rather any such differences should be understood as providing further clarification. Moreover, some potential additional modules are not shown to enhance readability.

Process 1400 initiates with provision of a bill or invoice by the merchant at module 1110 and receipt of the bill or invoice at module 1010 by the customer. Moreover, billing information from the merchant is also received by the payment processor at module 1312 (a corresponding module related to the merchant sending the billing information is not shown). It is likely that module 1312 will occur first in most instances, so that an order can be staged for the merchant and a code can be provided to the merchant for use in the bill/invoice of modules 1110 and 1010. At module 1214 a POS terminal receives a bill (or invoice, token document or other information related to an order to be paid) from the customer. At module 1216, the system (e.g. the payment processor) is accessed with a request to determine what payment should be made. At module 1317, the request of module 1216 is received by the payment processor.

Responsive to this request, the payment processor provides billing information to the POS terminal at module 1319, including the predetermined code to provide on any receipt. With this information, the customer can then make a payment at the POS at module 1020 (presumably with the POS terminal providing appropriate billing information to the customer, or confirming information on a bill). The POS terminal likewise receives the payment at module 1220. Having received the payment, the POS terminal notifies the payment processor at module 1223 that the payment was received. At module 1325, the payment processor receives confirmation from the payment processor of the payment made at the POS terminal (and potentially acknowledges this information in a separate module not shown). Additionally, the POS terminal provides a receipt to the customer at module 1230 and the customer receives the receipt at module 1030. This receipt includes the predetermined code which will match a code on the bill or invoice.

Backend processing of the payment continues, with receipt of notification of the payment from the POS terminal at the payment processor at module 1140. Moreover, related payment information is then sent to the merchant at module 1345. The merchant then accepts the payment information at module 1150 and the payment processor receives this acceptance at module 1353. Fulfillment then occurs with the merchant providing goods and/or services at module 1170 and the customer receiving these goods and/or services at module 1072.

Additionally, there is the matter of funds. At module 1285, funds are transferred from the POS terminal to the processor at module 1285. These funds are likewise received by the payment processor at module 1387. Funds are provided from the payment processor to the merchant at module 1389 and funds are received by the merchant at module 1190. This overall process may be repeated as needed for each transaction or order.

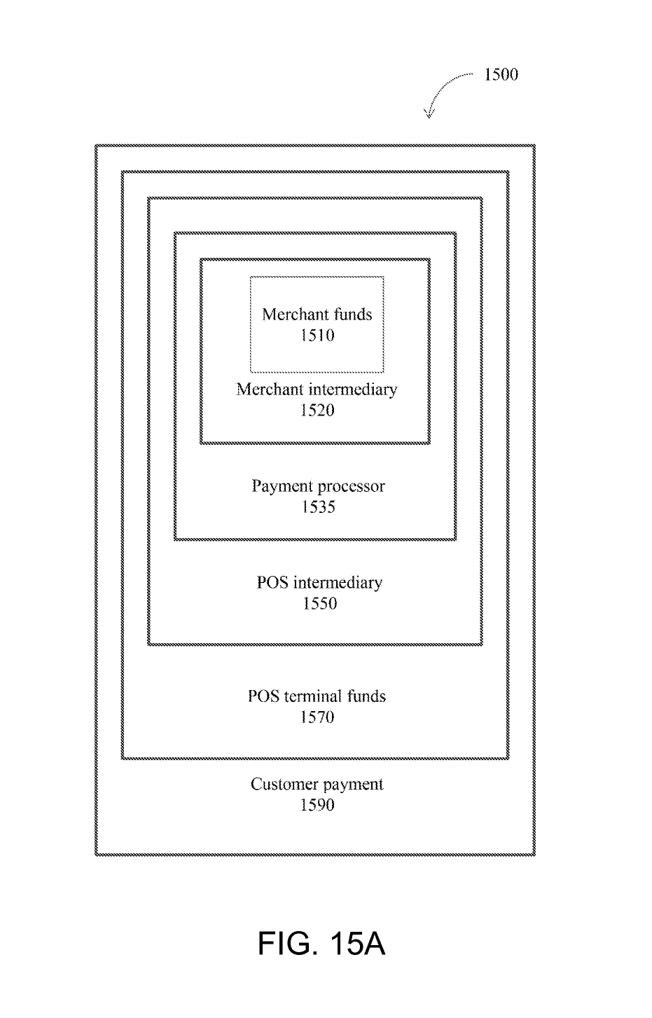

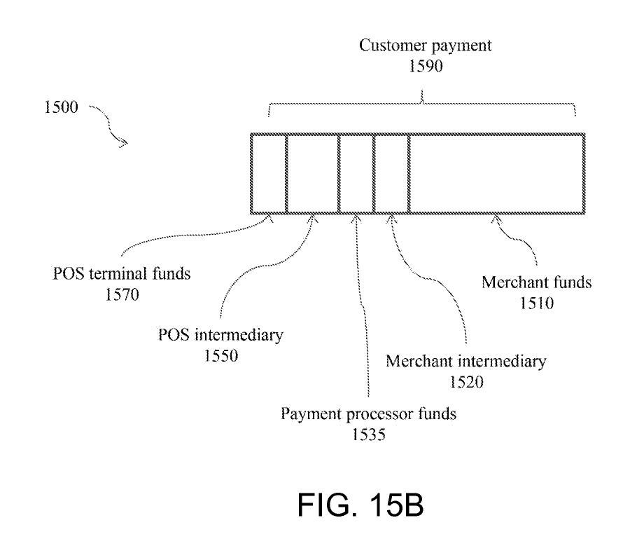

Note that in the process of making payments and handling or fulfilling orders, one may expect that funds transfer from and to various actors. FIGS. 15A and 15B provide some illustrations of this type of relationship of funds. FIG. 15A illustrates the various funds as one may view them, with fund structure 1500 starting with a customer payment 1590 to a POS terminal. Similarly, FIG. 15B shows the funds as they may be viewed as layers of a customer payment 1590. POS terminal funds 1570 provide funds to compensate the POS terminal for the order, and may be subdivided, for example. POS intermediary funds 1550 may compensate an intermediary actor, such as an aggregator or other type of payment processor handling orders specifically for the POS terminal. Payment processor funds 1535 specifically compensate the payment processor of FIG. 1, for example, and may be tuned by that payment processor, for example. Merchant intermediary funds 1520 compensate an intermediary which may process electronic payments for a merchant, for example. Merchant funds 1510 are the funds actually received by the merchant or merchant partner of FIG. 1, for example.

One may expect that each of these types of funds may be replicated multiple times for additional layers of transactions, such as in a situation where there are multiple merchants or a merchant is processing payments for suppliers on consignment, for example. Moreover, in some instances, POS intermediary 1550 and/or merchant intermediary 1520 may not exist. Additionally, arrangements may be made, such as by a payment processor, to reduce or enlarge any of the slices of funds for special promotions, for example. This may be transparent to the customer, or it may be used as an enticement to the customer, for example.

Division of funds for a specific order is specified by the payment economics for that order. An instance of payment economics provides a representation of how a payment will be broken down with various amounts apportioned to various actors. The various actors are expected to be entities which either accept payment, facilitate payment, process payment or in some way initiate or stage orders, for example.

Thus, one such actor would be a vendor or merchant which has agreed to provide goods or services to the customer. Another such actor may be a payment processor which is processing payments. Yet another actor may be a retail site such as one including a POS terminal which accepts payment from the customer. Other actors may be various intermediaries mentioned. Such intermediaries may be actual intermediaries interposed between actors already mentioned, for example. Other intermediaries may be facilitating a relationship between a merchant and the payment processor or a retail site payment processor, for example. Facilitating a relationship may involve something as simple as an initial introduction from which some form of commission is derived, or may involve an ongoing process of helping to smooth out problems or disputes and otherwise resolve potential issues.

Note that payment economics specify how payments divide, and are applied to a specific order at the time of payment. Thus, payment economics for a given order may specify an overall fee to be paid by a consumer in addition to an amount ultimately applied to payment to a merchant or vendor. Moreover, division of the overall fee comes out of the payment economics specification for the order as well. Thus, in one example, one may specify an overall fee of $3.50, with a breakdown of that fee into a portion to be paid to a retail location (e.g. where a POS terminal sits), a portion to be paid to a payment processor, and portion(s) for any third-party entities. Such third-party entities may be intermediaries, servicers, or other facilitating entities. Additionally, payment economics may specify a price (of underlying goods or services), but typically would not. Also, payment economics may specify divisions of funds in terms of absolute amounts, percentages, or some combination of absolute amounts and percentages. Payment economics are specified at the time of staging an order, and are referenced by information encoded or embodied in the token related to the order.

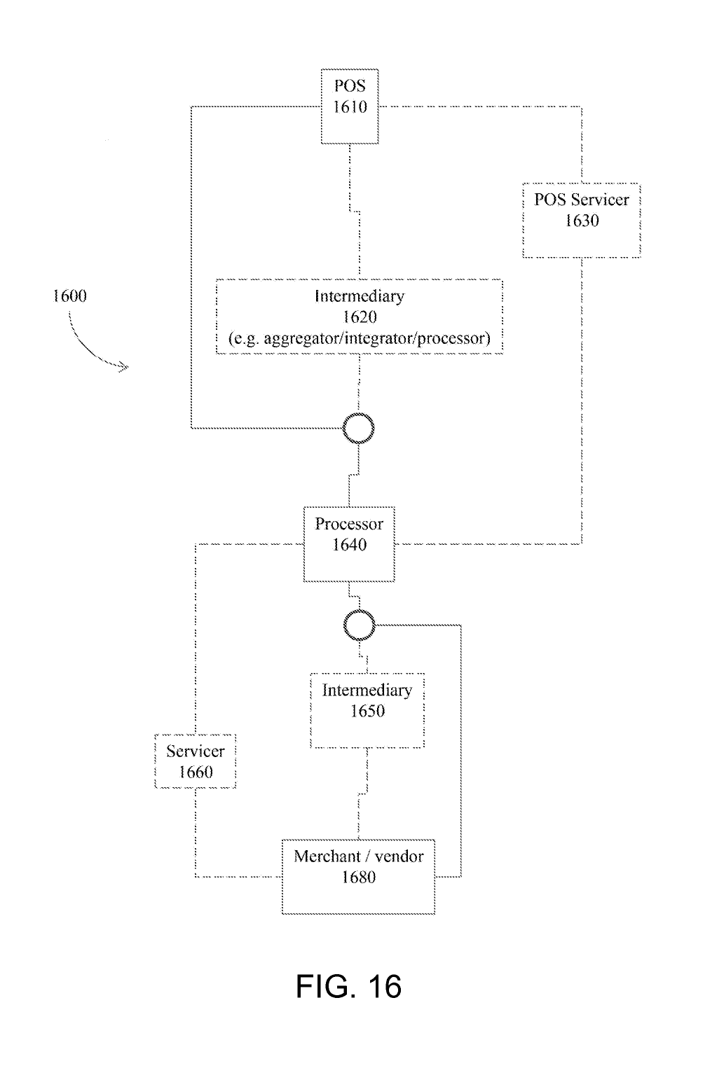

While payment economics specifies who gets funds, FIG. 16 illustrates potential flow of funds in one embodiment, and the flow may not be fully determined only by who ultimately receives funds. Funds may flow from one entity to another through various different paths. Structure 1600 illustrates how payments may flow showing various alternatives that may be involved. POS 1610 illustrates a retail site where a payment may be received from a consumer. Intermediary 1620 may be some form of intermediary which is interposed between POS retail site 1610 and processor 1640, and which may actually transfer funds from POS 1610 to processor 1640, for example. In contrast, POS servicer 1630 is illustrated as having a relationship with both POS 1610 and processor 1640 but not necessarily as interposed between the two entities. Thus, either POS 1610 or processor 1640 may transfer funds to POS servicer 1630. Additionally, there may be a direct path between POS 1610 and processor 1640. Note that these paths connote one- or two-way (e.g. mono-directional or bi-directional) flows for funds and/or information.

Processor 1640 essentially stands in the middle of a transaction or order. Processor 1640 may transfer funds to an intermediary 1650 which then transfers funds to merchant or vendor 1680. Alternatively, processor 1640 may transfer funds directly to merchant or vendor 1680 and either processor 1640 or merchant or vendor 1680 may then transfer funds to a servicer 1660 if needed. All of these transfers of funds are determined by payment economics encoded by a barcode or other encoding medium, which is used to provide input data to a POS terminal.

Note that payment economics may not be a final determination of how funds are transferred. The process of settling up orders or summarizing orders on a periodic basis may be used to correct for payments that were improperly applied on an immediate basis. For example, a payment processor may determine that encoded payment economics dictate that a payment corresponding to a certain threshold of orders is due to a certain entity at the time of completion of the order. However, upon further review, it may become apparent that the order has passed to a different threshold of orders, involving a different payment to the certain entity at the time of the order. This may be reflected in some sort of summary and settlement statement which may be issued by the payment processor. Moreover, the various payments may be specifically reflected in such statements along with transfers corresponding to those payments made on a periodic basis. This may be handled in a variety of ways, and reflects the ability to recover from or ameliorate problems or inaccuracies which may occur when one attempts to encode payment economics in advance of actual payment.

It is noted that the figures, individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between merchant, service provider, and POS terminal are performed via an automated computer-based system, such as an application program interface. Further, not all of the individual process or sub-process described are necessary for implementing the systems and methods described herein. As such, the embodiments presented in the figures are not intended to be limiting.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all embodiments of the present invention as contemplated by the inventor(s), and thus, are not intended to limit the present invention and the appended claims in any way.

One skilled in the art will appreciate that although specific examples and embodiments of the system and methods have been described for purposes of illustration, various modifications can be made without deviating from present invention. For example, embodiments of the present invention may be applied to many different types of databases, systems and application programs. Moreover, features of one embodiment may be incorporated into other embodiments, even where those features are not described together in a single embodiment within the present document.

1-7. (canceled)

8. A method of processing a payment to provide proof of payment for an order, comprising:
receiving with a payment-processor system a request for billing information from a system of a point-of-sale, the request for billing information resulting from a customer request to pay a merchant at the point-of-sale using a token document from the merchant having a predetermined code thereon;
providing with the payment-processor system the requested billing information to the point-of-sale system, including a bill amount, an additional fee amount and the predetermined code to be included on a receipt from the point-of-sale, wherein matching of the predetermined code on the receipt and the token document provides proof of payment for the order;
receiving with the payment-processor system confirmation of customer payment from the point-of-sale system; and
sending with the payment-processor system payment information to the merchant about the customer payment.

9. The method of claim 0, wherein the payment information sent to the merchant includes the predetermined code and the bill amount.

10. The method of claim 0, wherein the payment information sent to the merchant includes the bill amount.

11. The method of claim 10, further comprising receiving with the payment- processor system the predetermined code from a third party entity associated with processing of orders of the point-of-sale.

12. The method of claim 10, wherein the predetermined code includes exactly four digits.

13. The method of claim 12, wherein the predetermined code includes the last digits of an account number for the customer at the payment processor.

14. The method of claim 13, wherein the last digit of the account number is a checksum digit.

15. The method of claim 10, further comprising receiving with the payment-processor system funds from the point of service point-of-sale for customer payment.

16. The method of claim 15, further comprising providing with the payment-processor system funds from the point-of-sale for customer payment to the merchant.

17-20. (canceled)
